(19) United States
(12) Patent Application Publication
(10) Pub. No.: US 2014/0156392 A1
(43) Pub. Date: Jun. 5, 2014

(54) Commerce System and Method of Controlling the Commerce System Using Budgets for Personalized Shopping Lists

(71) Applicant: MYWORLD, INC., Scottsdale, AZ (US)

(72) Inventors: Kenneth J. Ouimet, David, CA (US); Wayne C. Neale, Phoenix, AZ (US)

(73) Assignee: MYWORLD, INC., Scottsdale, AZ (US)

(21) Appl. No.: 13/705,649

(22) Filed: Dec. 5, 2012

(51) Int. Cl. G06Q 30/06

(52) U.S. Cl. CPC G06Q 30/0633
USPC 705/14.49; 705/26.8; 705/26.7

(57) ABSTRACT

A commerce system has retailers offering products for sale to consumers. A database is provided including product information corresponding to a plurality of products. A shopping list is provided including a set of the products. The shopping list is evaluated to determine a difference between a budget and a total price of the shopping list. An interface is provided to alter the shopping list or total price of the shopping list based on the difference between the budget and the total price of the shopping list. The commerce system is controlled by displaying the budget and total price with the shopping list to influence purchasing decisions. An individualized offer is presented to reduce the total price of the shopping list. An alternate product is presented to add to the shopping list. A warning is provided to signify that the total price of the shopping list exceeds the budget.

### FIELD OF THE INVENTION

The present invention relates in general to consumer purchasing and, more particularly, to a commerce system and method of controlling the commerce system using budgets for personalized shopping lists.

### BACKGROUND OF THE INVENTION

Economic and financial modeling and planning are commonly used to estimate or predict the performance and outcome of real systems, given specific sets of input data of interest. An economic-based system will have many variables and influences which determine its behavior. A model is a mathematical expression or representation, which predicts the outcome or behavior of the system under a variety of conditions. In one sense, it is relatively easy to review historical data, understand its past performance, and state with relative certainty that past behavior of the system was indeed driven by the historical data. A more difficult task is to generate a mathematical model of the system, which predicts how the system will behave with different sets of data and assumptions.

In its basic form, the economic model can be viewed as a predicted or anticipated outcome of a system defined by a mathematical expression and driven by a given set of input data and assumptions. The mathematical expression is formulated or derived from principles of probability and statistics, often by analyzing historical data and corresponding known outcomes, to achieve a best fit of the expected behavior of the system to other sets of data. In other words, the model should be able to predict the outcome or response of the system to a specific set of data being considered or proposed, within a level of confidence, or an acceptable level of uncertainty.

Economic modeling has many uses and applications. One area in which modeling has been applied is in the retail environment. Grocery stores, general merchandise stores, specialty shops, and other retail outlets face stiff competition for limited consumers and business. Most, if not all, retail stores expend great effort to maximize sales, revenue, and profit. Economic modeling can be an effective tool in helping store owners and managers forecast and optimize business decisions. Yet, as an inherent reality of commercial transactions, the benefits bestowed on the retailer often come at a cost or disadvantage to the consumer. Maximizing sales and profits for a retailer does not necessarily expand competition and achieve the lowest price for the consumer.

On the other side of the transaction, the consumers are interested in quality, low prices, comparative product features, convenience, and receiving the most value for the money. Economic modeling can also be an effective tool in helping consumers achieve these goals. However, consumers have a distinct disadvantage in attempting to compile models for their benefit. Retailers have ready access to the historical transaction log (T-LOG) sales data, consumers do not. The advantage goes to the retailer. The lack of access to comprehensive, reliable, and objective product information essential to providing effective comparative shopping services restricts the consumer's ability to find the lowest prices, compare product features, and make the best purchase decisions.

For the consumer, some comparative product information can be gathered from various electronic and paper sources, such as online websites, paper catalogs, and media advertisements. However, such product information is sponsored by the retailer and slanted at best, typically limited to the specific retailer offering the product and presented in a manner favorable to the retailer. That is, the product information released by the retailer is subjective and incomplete, i.e., the consumer only sees what the retailer wants the consumer to see. For example, the pricing information may not provide a comparison with competitors for similar products. The product descriptions may not include all product features or attributes of interest to the consumer.

Alternatively, the consumer can visit all retailers offering a particular type of product and record the various prices, product descriptions, and retailer amenities to make a purchase decision. The brute force approach of one person physically traveling to or otherwise researching each retailer for all product information is impractical for most people. Many people do compare multiple retailers, e.g., when shopping online, particularly for big ticket items. Yet, the time people are willing to spend reviewing product information decreases rapidly with price. Little time is spent reviewing commodity items. In any case, the consumer has limited time to do comparative shopping and mere searching does not constitute an optimization of the purchasing decision. Optimization requires access to data, i.e., comprehensive, reliable, efficient, and objective product information, so the consumer remains hampered in achieving a level playing field with the retailer.

Consumers often are faced with constraints such as budgets, product availability, and retailer locations when making purchasing decisions. Budget limitations, for example, force consumers to forego ideal products for substitution products in order to maintain the budget. Once a consumer is at a retail location and realizes that the budget will not cover the desired purchases, the consumer can do little besides put items back or spend time going back through the aisles to find substitutes. The retail location where the consumer is shopping may not provide the same substitutions as competitors and may have higher pricing on desired goods. A need exists to optimize consumers' shopping lists in light of real world constraints including budgets, product availability, retailer locations, and pricing.

In a highly competitive market, the profit margin is paper thin and consumers and products are becoming more differentiated. Consumers are often well informed through electronic media and will have appetites only for specific products. Retailers must understand and act upon the market segment, which is tuned into their niche product area to make effective use of marketing dollars. The traditional mass marketing approach using gross market segmentation is insufficient to accurately predict consumer behavior across the various market segments. A more refined market strategy is needed to help focus resources on specific market segments that have the greatest potential of achieving a positive purchasing decision by the consumer for a product directed to that particular market segment. The retailers remain motivated to optimize marketing strategy, particularly pricing strategy, to maximize profit and revenue.

From the consumer's perspective, purchasing products from retailers can be both time-consuming and stressful. With limited budgets and time, consumers desire to be as efficient as possible. Consumers want to purchase products at a price within budget constraints, but often do not have time to compare prices at many different retail outlets before purchasing. Furthermore, searching for the lowest price for a particular product among retailers can be a difficult task, since accurate and reliable pricing data is often difficult to obtain. Additionally, the process of compiling and reviewing what little useful information is readily available to the consumer far exceeds any benefit the consumer might derive from the information.

### SUMMARY OF THE INVENTION

A need exists to provide a mechanism to assist consumers by determining the most efficient and valuable options for purchasing products from various retailers. Accordingly, in one embodiment, the present invention is a method of controlling a commerce system comprising the steps of providing a database including product information corresponding to a plurality of products, providing a shopping list including a set of the products, evaluating the shopping list to determine a difference between a budget and a total price of the shopping list, providing an interface to alter the shopping list or total price of the shopping list based on the difference between the budget and the total price of the shopping list, and controlling the commerce system by displaying the budget and total price with the shopping list to influence purchasing decisions.

In another embodiment, the present invention is a method of controlling a commerce system comprising the steps of providing product information corresponding to a plurality of products, providing a shopping list including a set of the products, determining a difference between a budget and a price of the shopping list, providing an interface to alter the shopping list or price of the shopping list based on the difference between the budget and the price of the shopping list, and displaying the budget and price with the shopping list to influence purchasing decisions.

In another embodiment, the present invention is a method of controlling a commerce system comprising the steps of determining a difference between a budget and a price of a shopping list, providing an interface to alter the shopping list or price of the shopping list based on the difference between the budget and the price of the shopping list, and displaying the budget and price with the shopping list.

In another embodiment, the present invention is a computer program product usable with a programmable computer processor having a computer readable program code embodied in a computer usable medium for controlling a commerce system comprising the steps of determining a difference between a budget and a price of a shopping list, providing an interface to alter the shopping list or price of the shopping list based on the difference between the budget and the price of the shopping list, and displaying the budget and price with the shopping list.

### BRIEF DESCRIPTION OF THE DRAWINGS

FIG. 1 illustrates a commerce system which analyzes T-LOG data to generate demand models and executes a business plan in accordance with those demand models;

FIG. 2 illustrates a commercial supply, distribution, and consumption chain controlled by a demand model;

FIG. 3 illustrates commercial transactions between consumers and retailers with the aid of a consumer service provider;

FIG. 4 illustrates an electronic communication network between the consumers and consumer service provider;

FIG. 5 illustrates a computer system operating with the electronic communication network;

FIG. 6 illustrates a consumer profile registration webpage with the consumer service provider;

FIG. 7 illustrates a consumer login webpage for the consumer service provider;

FIG. 8 illustrates interaction between the consumers, retailers, and consumer service provider to generate an optimized shopping list with discount offers;

FIG. 9 illustrates collecting product information from retailer websites directly by the consumer service provider or indirectly using consumer computers;

FIG. 10 illustrates a home webpage for the consumer when communicating with the consumer service provider;

FIG. 11 illustrates a search webpage for the consumer to locate preferred retailers on a map;

FIG. 12 illustrates a plurality of links to consumer shopping lists;

FIG. 13 illustrates a webpage for the consumer to select product categories when creating or modifying the shopping list;

FIG. 14 illustrates a dairy products webpage for the consumer to select product attributes and assign weighting factors;

FIG. 15 illustrates a breakfast cereal webpage for the consumer to select product attributes and assign weighting factors;

FIG. 16 illustrates a cell phone for the consumer to select product attributes and assign weighting factors;

FIG. 17 illustrates creating an optimized shopping list from the consumer-defined product attributes and weighting factors and product information stored in a database;

FIG. 18 illustrates selection of a retailer with the highest net value product;

FIG. 19 illustrates an optimized shopping list to aid the consumer with purchasing decisions;

FIG. 20 illustrates products proposed for the optimized shopping list based on a marketing strategy;

FIG. 21 illustrates products for the optimized shopping list based on product categories in a virtual retailer;

FIGS. 22a-22b illustrate demand curves of price versus unit sales;

FIG. 23 illustrates a trip planner for the consumer to organize a shopping excursion;

FIGS. 24a-24c illustrate the optimized shopping list with products aggregated for competing retailers;

FIG. 25 illustrates evaluating a shopping list and budget to provide recommendations and offers and alter the shopping list;

FIG. 26 illustrates an interface for a consumer to create or edit a shopping list with a budget;

FIGS. 27a-27c illustrate an interface for creating and managing a budget;

FIGS. 28a-28d illustrate an interface for selecting product substitutions and accepting individualized offers;

FIGS. 29a-29b illustrate an interface for balancing a budget for a shopping list using relative item importance; and

FIG. 30 illustrates the process of controlling activity within the commerce system by enabling the consumer to optimize a shopping list in light of budget constraints.

### DETAILED DESCRIPTION OF THE DRAWINGS

The present invention is described in one or more embodiments in the following description with reference to the figures, in which like numerals represent the same or similar elements. While the invention is described in terms of the best mode for achieving the invention's objectives, it will be appreciated by those skilled in the art that it is intended to cover alternatives, modifications, and equivalents as may be included within the spirit and scope of the invention as defined by the appended claims and their equivalents as supported by the following disclosure and drawings.

Economic and financial modeling and planning is an important business tool that allows companies to conduct business planning, forecast demand, and optimize prices and promotions to meet profit and/or revenue goals. Economic modeling is applicable to many businesses, such as manufacturing, distribution, wholesale, retail, medicine, chemicals, financial markets, investing, exchange rates, inflation rates, pricing of options, value of risk, research and development, and the like.

In the face of mounting competition and high expectations from investors, most, if not all, businesses must look for every advantage they can muster in maximizing market share and profits. The ability to forecast demand, in view of pricing and promotional alternatives, and to consider other factors which materially affect overall revenue and profitability is vital to the success of the bottom line, and the fundamental need to not only survive but to prosper and grow.

In particular, economic modeling is essential to businesses that face thin profit margins, such as general consumer merchandise and other retail outlets. Many businesses are interested in economic modeling and forecasting, particularly when the model provides a high degree of accuracy or confidence. Such information is a powerful tool and highly valuable to the business. While the present discussion will involve a retailer, it is understood that the system described herein is applicable to data analysis for other members in the chain of commerce, or other industries and businesses having similar goals, constraints, and needs.

A retailer routinely collects T-LOG sales data for most if not all products in the normal course of business. Using the T-LOG data, the system generates a demand model for one or more products at one or more stores. The model is based upon the T-LOG data for that product and includes a plurality of parameters. The values of the parameters define the demand model and can be used for making predictions about the future sales activity for the product. For example, the model for each product can be used to predict future demand or sales of the product at that store in response to a proposed price, associated promotions or advertising, as well as impact from holidays and local seasonal variations. Promotion and advertising increase consumer awareness of the product.

An economic demand model analyzes historical retail T-LOG sales data to gain an understanding of retail demand as a function of factors such as price, promotion, time, consumer, seasonal trends, holidays, and other attributes of the product and transaction. The demand model can be used to forecast future demand by consumers as measured by unit sales. Unit sales are typically inversely related to price, i.e., the lower the price, the higher the sales. The quality of the demand model—and therefore the forecast quality—is directly affected by the quantity, composition, and accuracy of historical T-LOG sales data provided to the model.

The retailer makes business decisions based on forecasts. The retailer orders stock for replenishment purposes and selects items for promotion or price discount. To support good decisions, it is important to quantify the quality of each forecast. The retailer can then review any actions to be taken based on the accuracy of the forecasts on a case-by-case basis.

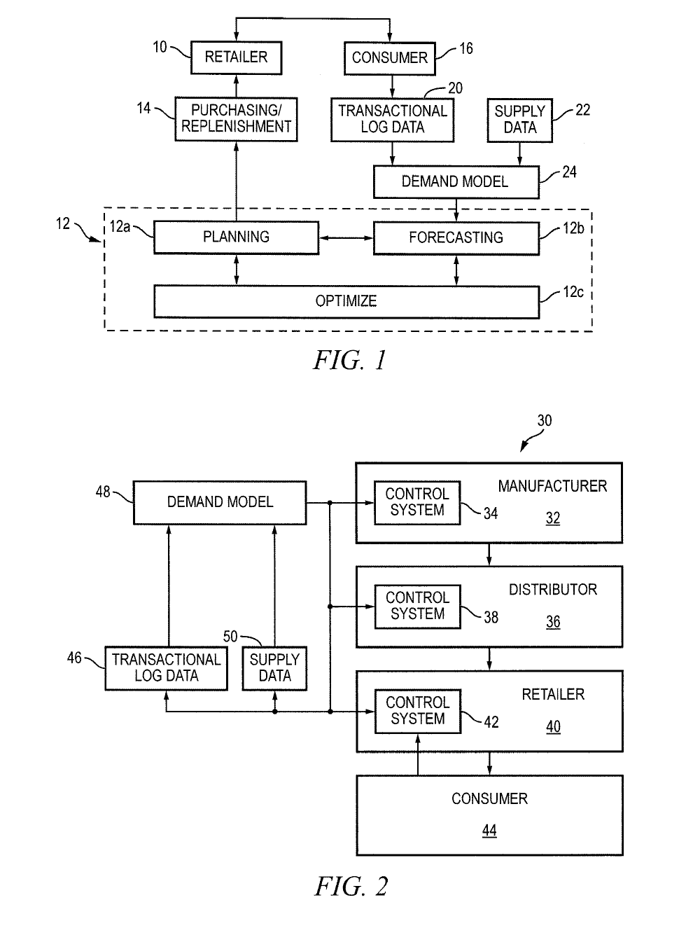

Referring to FIG. 1, retailer 10 has certain product lines or services available to consumers as part of its business plan 12. The terms products and services are interchangeable in the commercial system. Retailer 10 can be a food store chain, general consumer product retailer, drug store, discount warehouse, department store, apparel store, specialty store, or service provider. Retailer 10 has the ability to set pricing, order inventory, run promotions, arrange its product displays, collect and maintain historical sales data, and adjust its strategic business plan.

Business plan 12 includes planning 12a, forecasting 12b, and optimization 12c steps and operations. Business plan 12 gives retailer 10 the ability to evaluate performance and trends, make strategic decisions, set pricing, order inventory, formulate and run promotions, hire employees, expand stores, add and remove product lines, organize product shelving and displays, select signage, and the like. Business plan 12 allows retailer 10 to analyze data, evaluate alternatives, run forecasts, and make decisions to control its operations. With input from the planning 12a, forecasting 12b, and optimization 12c steps and operations of business plan 12, retailer 10 undertakes various purchasing or replenishment operations 14. Retailer 10 can change business plan 12 as needed.

Retailer 10 routinely enters into sales transactions with customer or consumer 16. In fact, retailer 10 maintains and updates its business plan 12 to increase the number of transactions (and thus revenue and/or profit) between retailer 10 and consumer 16. Consumer 16 can be a specific individual, account, or business entity.

For each sale transaction entered into between retailer 10 and consumer 16, information describing the transaction is stored in T-LOG data 20. When a consumer goes through the check-out at a grocery or any other retail store, each of the items to be purchased is scanned and data is collected and stored by a point-of-sale (POS) system, or other suitable data storage system, in T-LOG data 20. The data includes the then current price, promotion, and merchandizing information associated with the product along with the units purchased, and the dollar sales. The date and time, and store and consumer information corresponding to that purchase are also recorded.

T-LOG data 20 contains one or more line items for each retail transaction, such as those shown in Table 1. Each line item includes information or attributes relating to the transaction, such as store number, product number, time of transaction, transaction number, quantity, current price, profit, promotion number, and consumer category or type number. The store number identifies a specific store; product number identifies a product; time of transaction includes date and time of day; quantity is the number of units of the product; current price (in US dollars) can be the regular price, reduced price, or higher price in some circumstances; profit is the difference between current price and cost of selling the item; promotion number identifies any promotion associated with the product, e.g., flyer, ad, discounted offer, sale price, coupon, rebate, end-cap, etc.; consumer identifies the consumer by type, class, region, demographics, or individual, e.g., discount card holder, government sponsored or under-privileged, volume purchaser, corporate entity, preferred consumer, or special member. T-LOG data 20 is accurate, observable, and granular product information based on actual retail transactions within the store. T-LOG data 20 represents the known and observable results from the consumer buying decision or process. T-LOG data 20 may contain thousands of transactions for retailer 10 per store per day, or millions of transactions per chain of stores per day.

TABLE 1
T-LOG Data

| STORE | PRODUCT | TIME | TRANS | QTY | PRICE | PROFIT | PROMOTION | CONSUMER |
|---|---|---|---|---|---|---|---|---|
| S1 | P1 | D1 | T1 | 1 | 1.50 | 0.20 | PROMO1 | C1 |
| S1 | P2 | D1 | T1 | 2 | 0.80 | 0.05 | PROMO2 | C1 |
| S1 | P3 | D1 | T1 | 3 | 3.00 | 0.40 | PROMO3 | C1 |
| S1 | P4 | D1 | T2 | 4 | 1.80 | 0.50 | 0 | C2 |
| S1 | P5 | D1 | T2 | 1 | 2.25 | 0.60 | 0 | C2 |
| S1 | P6 | D1 | T3 | 10 | 2.65 | 0.55 | PROMO4 | C3 |
| S1 | P1 | D2 | T1 | 5 | 1.50 | 0.20 | PROMO1 | C4 |
| S2 | P7 | D3 | T1 | 1 | 5.00 | 1.10 | PROMO5 | C5 |
| S2 | P1 | D3 | T2 | 2 | 1.50 | 0.20 | PROMO1 | C6 |
| S2 | P8 | D3 | T2 | 1 | 3.30 | 0.65 | 0 | C6 |

The first line item shows that on day/time D1, store S1 has transaction T1 in which consumer C1 purchases one product P1 at $1.50. The next two line items also refer to transaction T1 and day/time D1, in which consumer C1 also purchases two products P2 at $0.80 each and three products P3 at price $3.00 each. In transaction T2 on day/time D1, consumer C2 has four products P4 at price $1.80 each and one product P5 at price $2.25. In transaction T3 on day/time D1, consumer C3 has ten products P6 at $2.65 each, in his or her basket. In transaction T1 on day/time D2 (different day and time) in store S1, consumer C4 purchases five products P1 at price $1.50 each. In store S2, transaction T1 with consumer C5 on day/time D3 (different day and time) involves one product P7 at price $5.00. In store S2, transaction T2 with consumer C6 on day/time D3 involves two products P1 at price $1.50 each and one product P8 at price $3.30.

Table 1 further shows that product P1 in transaction T1 has promotion PROMO1. PROMO1 can be any suitable product promotion such as a front-page featured item in a local advertising flyer. Product P2 in transaction T1 has promotion PROMO2 as an end-cap display in store S1. Product P3 in transaction T1 has promotion PROMO3 as a reduced sale price with a discounted offer. Product P4 in transaction T2 on day/time D1 has no promotional offering. Likewise, product P5 in transaction T2 has no promotional offering. Product P6 in transaction T3 on day/time D1 has promotion PROMO4 as a volume discount for 10 or more items. Product P7 in transaction T1 on day/time D3 has promotion PROMO5 as a $0.50 rebate. Product P8 in transaction T2 has no promotional offering. A promotion may also be classified as a combination of promotions, e.g., flyer with sale price, end-cap with rebate, or individualized discounted offer as described below.

Retailer 10 may also provide additional information to T-LOG data 20 such as promotional calendar and events, holidays, seasonality, store set-up, shelf location, end-cap displays, flyers, and advertisements. The information associated with a flyer distribution, e.g., publication medium, run dates, distribution, product location within flyer, and advertised prices, is stored within T-LOG data 20.

Supply data 22 is also collected and recorded from manufacturers and distributors. Supply data 22 includes inventory or quantity of products available at each location in the chain of commerce, i.e., manufacturer, distributor, and retailer. Supply data 22 includes product on the store shelf and replenishment product in the retailer's storage area.

With T-LOG data 20 and supply data 22 collected, various suitable methods or algorithms can be used to analyze the data and generate demand model 24. Model 24 may use a combination of linear, nonlinear, deterministic, stochastic, static, or dynamic equations or models for analyzing T-LOG data 20 or aggregated T-LOG data and supply data 22 and making predictions about consumer behavior to future transactions for a particular product at a particular store, or across entire product lines for all stores. Model 24 is defined by a plurality of parameters and can be used to generate unit sales forecasting, price optimization, promotion optimization, markdown/clearance optimization, assortment optimization, merchandise and assortment planning, seasonal and holiday variance, and replenishment optimization. Model 24 has a suitable output and reporting system that enables the output from model 24 to be retrieved and analyzed for updating business plan 12.

In FIG. 2, a commerce system 30 is shown involving the movement of goods between members of the system. Manufacturer 32 produces goods in commerce system 30. Manufacturer 32 uses control system 34 to receive orders, control manufacturing and inventory, and schedule deliveries. Distributor 36 receives goods from manufacturer 32 for distribution within commerce system 30. Distributor 36 uses control system 38 to receive orders, control inventory, and schedule deliveries. Retailer 40 receives goods from distributor 36 for sale within commerce system 30. Retailer 40 uses control system 42 to place orders, control inventory, and schedule deliveries with distributor 26. Retailer 40 sells goods to consumer 44. Consumer 44 patronizes retailer's establishment either in person or by using online ordering. The consumer purchases are entered into control system 42 of retailer 40 as T-LOG data 46.

The purchasing decisions made by consumer 44 drive the manufacturing, distribution, and retail portions of commerce system 30. More purchasing decisions made by consumer 44 for retailer 40 lead to more merchandise movement for all members of commerce system 30. Manufacturer 32, distributor 36, and retailer 40 utilize demand model 48 (similar to model 24), via respective control systems 34, 38, and 42, to control and optimize the ordering, manufacturing, distribution, sale of the goods, and otherwise execute respective business plan 12 within commerce system 30 in accordance with the purchasing decisions made by consumer 44.

Manufacturer 32, distributor 36, and retailer 40 provide historical T-LOG data 46 and supply data 50 to demand model 48 by electronic communication link, which in turn generates forecasts to predict the need for goods by each member and control its operations. In one embodiment, each member provides its own historical T-LOG data 46 and supply data 50 to demand model 48 to generate a forecast of demand specific to its business plan 12. Alternatively, all members can provide historical T-LOG data 46 and supply data 50 to demand model 48 to generate composite forecasts relevant to the overall flow of goods. For example, manufacturer 32 may consider a proposed discounted offer, rebate, promotion, seasonality, or other attribute for one or more goods that it produces. Demand model 48 generates the forecast of sales based on available supply and the proposed price, consumer, rebate, promotion, time, seasonality, or other attribute of the goods. The forecast is communicated to control system 34 by electronic communication link, which in turn controls the manufacturing process and delivery schedule of manufacturer 32 to send goods to distributor 36 based on the predicted demand ultimately determined by the consumer purchasing decisions. Likewise, distributor 36 or retailer 40 may consider a proposed discounted offer, rebate, promotion, or other attributes for one or more goods that it sells. Demand model 48 generates the forecast of demand based on the available supply and proposed price, consumer, rebate, promotion, time, seasonality, and/or other attribute of the goods. The forecast is communicated to control system 38 or control system 42 by electronic communication link, which in turn controls ordering, distribution, inventory, and delivery schedule for distributor 36 and retailer 40 to meet the predicted demand for goods in accordance with the forecast.

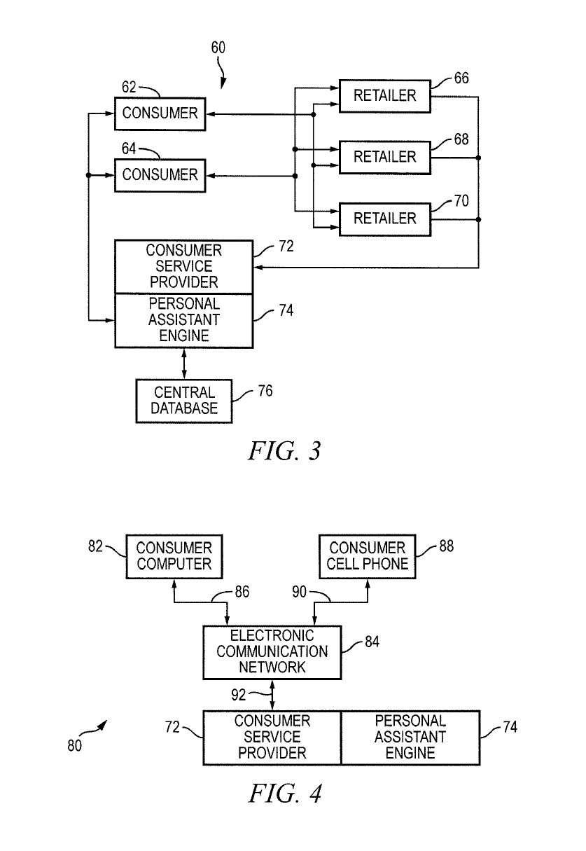

FIG. 3 illustrates a commerce system 60 with consumers 62 and 64 engaged in purchasing transactions with retailers 66, 68, and 70. Retailers 66-70 are supplied by manufacturers and distributors, as described in FIG. 2. Retailers 66-70 are typically local to consumers 62-64, i.e., retailers that the consumers will likely patronize. Retailers 66-70 can also be remote from consumers 62-64 with transactions handled by electronic communication medium, e.g., phone or online website via personal computer, and delivered electronically or by common carrier, depending on the nature of the goods. Consumers 62-64 patronize retailers 66-70 either in person in the retailer's store or by electronic communication medium to select one or more items for purchase from one or more retailers. For example, consumer 62 can visit the store of retailer 66 in person and select product P1 for purchase. Consumer 62 can contact retailer 68 by phone or email and select product P2 for purchase. Consumer 64 can browse the website of retailer 70 using a personal computer and select product P3 for purchase. Accordingly, consumers 62-64 and retailers 66-70 can engage in regular commercial transactions within commerce system 60.

As described herein, manufacturer 32, distributor 36, retailers 66-70, consumers 62-64, and consumer service provider 72 are considered members of commerce system 60. The retailer generally refers to the seller of the product and consumer generally refers to the buyer of the product. Depending on the transaction within commerce system 60, manufacturer 32 can be the seller and distributor 36 can be the buyer, or distributor 36 can be the seller and retailers 66-70 can be the buyer, or manufacturer 32 can be the seller and consumers 62-64 can be the buyer.

Each consumer goes through a product evaluation and purchasing decision process each time a particular product is selected for purchase. Some product evaluations and purchasing decision processes are simple and routine. For example, when consumer 62 is conducting weekly shopping in the grocery store, the consumer sees a needed item or item of interest, e.g., canned soup. Consumer 62 may have a preferred brand, size, and flavor of canned soup. Consumer 62 selects the preferred brand, size, and flavor sometimes without consideration of price, places the item in the basket, and moves on. The product evaluation and purchasing decision process can be almost automatic and instantaneous but nonetheless still occurs based on prior experiences and preferences. Consumer 62 may pause during the product evaluation and purchasing decision process and consider other canned soup options. Consumer 62 may want to try a different flavor or another brand offering a lower price. As the price of the product increases, the product evaluation and purchasing decision process usually becomes more involved. If consumer 62 is shopping for a major appliance, the product evaluation and purchasing decision process may include consideration of several manufacturers, visits to multiple retailers, review of features and warranty, talking to salespersons, reading consumer reviews, and comparing prices. In any case, understanding the consumer's approach to the product evaluation and purchasing decision process is part of an effective model or comparative shopping service. The model must assist the consumer in finding the optimal price and product attributes, e.g., brand, quality, quantity, size, features, ingredients, service, warranty, and convenience, that are important to the consumer and tip the purchasing decision toward selecting a particular product and retailer.

In FIG. 3, consumer service provider 72 is a part of commerce system 60. Consumer service provider 72 is a third party that assists consumers 62-64 with the product evaluation and purchasing decision process by providing access to an optimization model or comparative shopping service. Consumer service provider 72 works with consumers 62-64 and retailers 66-70 to control commercial transactions within commerce system 60 by optimizing the selection of products by price and other attributes. More specifically, consumer service provider 72 operates and maintains personal assistant engine 74 that prioritizes product attributes and optimizes product selection according to consumer-weighted preferences. The product attributes and consumer-weighted preferences are stored in central database 76. In addition, personal assistant engine 74 generates a discounted offer for a product to entice a positive purchasing decision by a specific consumer. Personal assistant engine 74 saves the consumer considerable time and money by providing access to a comprehensive, reliable, and objective optimization model or comparative shopping service.

The personal assistant engine 74 can be made available to consumers 62-64 via computer-based online website or other electronic communication medium, e.g., wireless cell phone or other personal communication device. FIG. 4 shows an electronic communication network 80 for transmitting information between consumers 62-64, retailers 66-70, and consumer service provider 72. A consumer operating with computer 82 is connected to electronic communication network 84 by way of communication channel or link 86. Likewise, a consumer operating with a cellular telephone or other wireless communication device 88 is connected to electronic communication network 84 by way of communication channel or link 90. The electronic communication network 84 is a distributed network of interconnected routers, gateways, switches, and servers, each with a unique internet protocol (IP) address to enable communication between individual computers, cellular telephones, electronic devices, or nodes within the network. In one embodiment, electronic communication network 84 is a global, open-architecture network, commonly known as the Internet. Communication channels 86 and 90 are bi-directional and transmit data between consumer computer 82 and consumer cell phone 88 and electronic communication network 84 in a hard-wired or wireless configuration. For example, consumer computer 82 has email, texting, and Internet capability, and consumer cell phone 88 has email, texting, and Internet capability.

The electronic communication network 80 further includes consumer service provider 72 with personal assistant engine 74 in electronic communication with network 84 over communication channel or link 92. Communication channel 92 is bi-directional and transmits data between consumer service provider 72 and electronic communication network 84 in a hard-wired or wireless configuration.

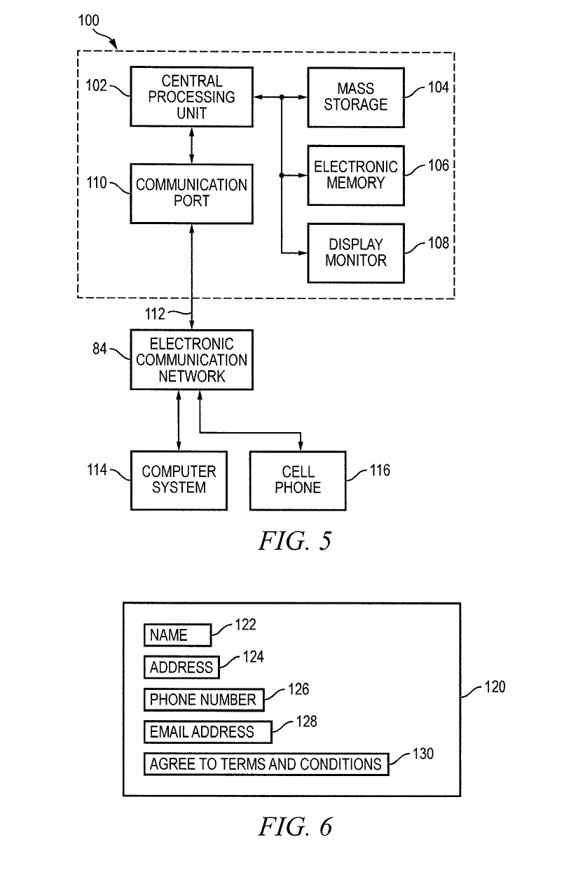

Further detail of the computer systems used in electronic communication network 80 is shown in FIG. 5 as a simplified computer system 100 for executing the software program used in the electronic communication process. Computer system 100 is a general-purpose computer including a central processing unit or microprocessor 102, mass storage device or hard disk 104, electronic memory 106, display monitor 108, and communication port 110. Communication port 110 represents a modem, high-speed Ethernet link, wireless, or other electronic connection to transmit and receive input/output (I/O) data over communication link 112 to electronic communication network 84. Computer system or server 114 can be configured as shown for computer 100. Computer system 114 and cellular telephone 116 transmit and receive information and data over communication network 84.

Computer systems 100 and 114 can be physically located in any location with access to a modem or communication link to network 84. For example, computer 100 or 114 can be located in the consumer's home or business office. Consumer service provider 72 may use computer system 100 or 114 in its business office. Alternatively, computer 100 or 114 can be mobile and follow the user to any convenient location, e.g., remote offices, consumer locations, hotel rooms, residences, vehicles, public places, or other locales with electronic access to electronic communication network 84. The consumer can access consumer service provider 72 by mobile application operating in cell phone 116.

Each of the computers runs application software and computer programs, which can be used to display user interface screens, execute the functionality, and provide the electronic communication features as described below. The application software includes an Internet browser, local email application, word processor, spreadsheet, and the like. In one embodiment, the screens and functionality come from the application software, i.e., the electronic communication runs directly on computer system 100 or 114. Alternatively, the screens and functions are provided remotely from one or more websites on servers within electronic communication network 84.

The software is originally provided on computer readable media, such as compact disks (CDs), external drive, or other mass storage medium. Alternatively, the software is downloaded from electronic links, such as the host or vendor website. The software is installed onto the computer system hard drive 104 and/or electronic memory 106, and is accessed and controlled by the computer operating system. Software updates are also electronically available on mass storage medium or downloadable from the host or vendor website. The software, as provided on the computer readable media or downloaded from electronic links, represents a computer program product containing computer readable program code embodied in a computer program medium. Computers 100 and 114 run application software for executing instructions for communication between consumer computers 82 and 88 and consumer service provider 72, gathering product information, generating consumer models or comparative shopping services, and evaluating promotional programs. The application software is an integral part of the control of purchasing decisions and other commercial activity within commerce system 60.

The electronic communication network 80 can be used for a variety of business, commercial, personal, educational, and government purposes or functions. For example, the consumer using computer 114 can communicate with consumer service provider 72 operating on computer 100, and the consumer using cellular telephone 116 can communicate with consumer service provider 72 operating on computer 100. The electronic communication network 80 is an integral part of a business, commercial, professional, educational, government, or social network involving the interaction of people, processes, and commerce.

To interact with consumer service provider 72, consumers 62 and 64 first create an account and profile with the consumer service provider. Consumers 62 and 64 can use some features offered by consumer service provider 72 without creating an account, but full access requires completion of a registration process. The consumer accesses website 120 operated by consumer service provider 72 on computer system 100 and provides data to complete the registration and activation process, as shown in FIG. 6. The consumer can access website 120 using computer 114 or cellular telephone 116 by typing the uniform resource locator (URL) for website 120, or by clicking on a banner located on another website which re-directs the consumer to a predetermined landing page for website 120. The data provided by the consumer to consumer service provider 72 may include name in block 122, address with zip code in block 124, phone number in block 126, email address in block 128, and other information and credentials necessary to establish a profile and identity for the consumer. The consumer's address and zip code are important as shopping is often a local activity. The consumer agrees to the terms and conditions of conducting electronic communication through consumer service provider 72 in block 130.

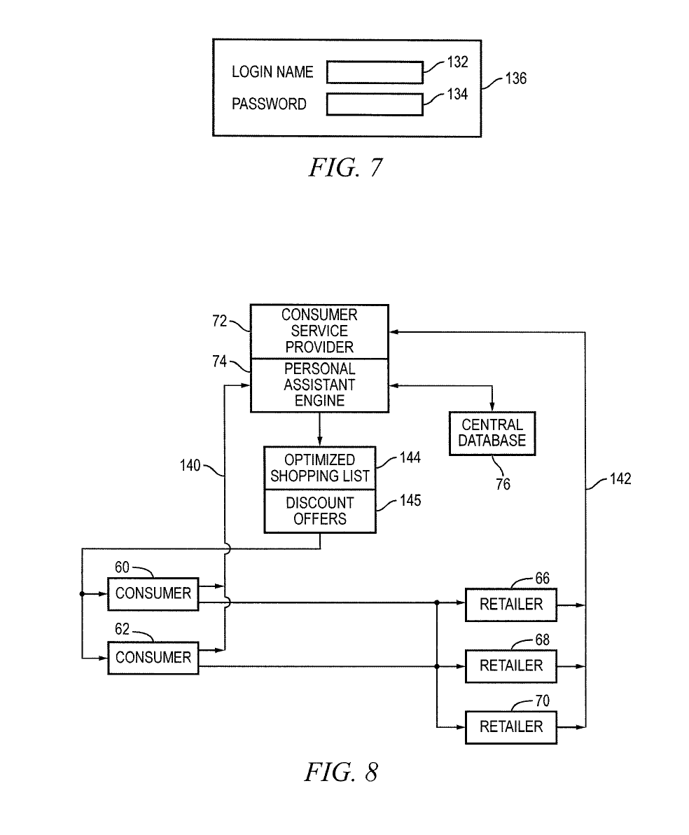

The consumer's profile is stored and maintained within central database 76. The consumer can access and update his or her profile or interact with personal assistant engine 74 by entering login name 132 and password 134 in webpage 136, as shown in FIG. 7. The consumer name can be any personal name, user name, number, or email address that uniquely identifies the consumer and the password can be assigned to or selected by the consumer. Accordingly, the consumer's profile and personal data remains secure and confidential within consumer service provider 72.

One feature of personal assistant engine 74 allows the consumer to enter a list of products of interest or need, i.e., to create a shopping list. FIG. 8 illustrates consumers 62 and 64 in communication with personal assistant engine 74 by electronic link 140. Once logged-in to consumer service provider 72, consumers 62 and 64 can provide commonly purchased products or anticipated purchase products in the form of a shopping list to personal assistant engine 74 for storage in central database 76. Each product will have product attributes weighted by consumer preference. The consumer weighted attribute values reflect the level of importance or preference that the consumer bestows on each product attribute. The available product attributes can be product-specific attributes, diet/health/nutrient related product attributes, lifestyle related product attributes, environment related product attributes, allergen related product attributes, and social/society related product attributes. The product-specific attributes can include brand, ingredients, size, price, freshness, retailer preference, warranty, and the like. The consumer can also identify a specific preferred retailer as an attribute with an assigned preference level based on convenience and personal experience.

Personal assistant engine 74 stores the shopping list and weighted product attributes of each consumer in central database 76 for future reference and updating. Personal assistant engine 74 can also store prices, product descriptions, names and locations of the retail stores selling the products, offer histories, purchase histories, as well as various rules, policies and algorithms. The individual products in the shopping list can be added or deleted and the weighted product attributes can be changed by the consumer. The shopping list entered into personal assistant engine 74 is defined by each consumer and allows consumer service provider 72 to track products and preferred retailers as selected by the consumer.

In order to store and maintain a shopping list for each consumer, personal assistant engine 74 must have access to up-to-date, comprehensive, reliable, and objective retailer product information. Consumer service provider 72 maintains central database 76 with up-to-date, comprehensive, reliable, and objective retailer product information. The product information includes the product description, product attributes, regular retail pricing, and discounted offers. Consumer service provider 72 must actively and continuously gather up-to-date product information in order to maintain central database 76. In one approach to gathering product information, retailers 66-70 may grant access to T-LOG data 46 for use by consumer service provider 72. T-LOG data 46 collected during consumer check-out can be sent electronically from retailers 66-70 to consumer service provider 72, as shown by communication link 142 in FIG. 8. As noted in the background, retailers may be reluctant to grant access to T-LOG data 46, particularly without quid pro quo. However, as consumer service provider 72 gains acceptance and consumers 62-64 come to rely on the service to make purchase decisions, retailers 66-70 will be motivated to participate.

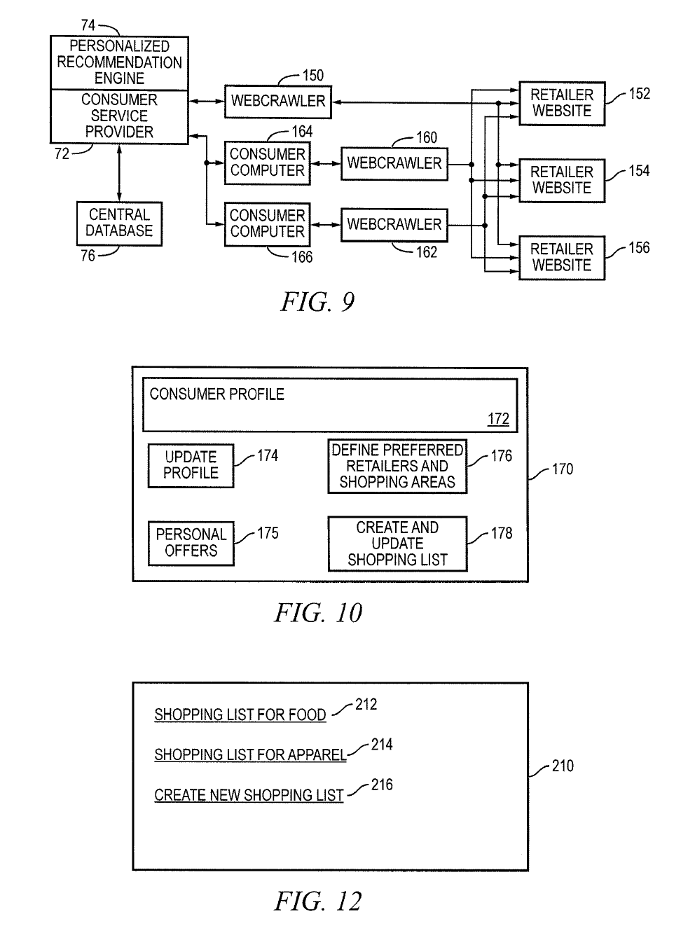

One or more retailers 66-70 may decline to provide access to its T-LOG data for use with personal assistant engine 74. In such cases, consumer service provider 72 can exercise a number of alternative data gathering approaches and sources. In one embodiment, consumer service provider 72 utilizes computer-based webcrawlers or other searching software to access retailer websites for pricing and other product information. In FIG. 9, webcrawler 150 operates within the software of computer 100 or 114 used by consumer service provider 72. Consumer service provider 72 dispatches webcrawler 150 to make requests for product information from websites 152, 154, and 156 of retailers 66, 68, and 70, respectively. Webcrawler 150 collects and returns the product information to personal assistant engine 74 for storage within central database 76. For example, webcrawler 150 identifies products available from each of retailer websites 152-156 and requests pricing and other product information for each of the identified products. Webcrawler 150 navigates and parses each page of retailer websites 152-156 to locate pricing and other product information. The parsing operation involves identifying and recording product description, universal product code (UPC), price, ingredients, size, and other product information as recovered by webcrawler 150 from retailer websites 152-156. In particular, the parsing operation can identify discounted offers and special pricing from retailers 66-70. The discounted pricing can be used in part to formulate individualized “one-to-one” offers. The product information from retailer websites 152-156 is sorted and stored in central database 76.

Consumer service provider 72 can also dispatch webcrawlers 160 and 162 from computers 164 and 166 used by consumers 62-64, or from consumer cell phone 116, or other electronic communication device, to access and request product information from retailer websites or portals 152-156 or other electronic communication medium or access point. During the registration process of FIG. 6, consumer service provider 72 acquires the IP address of consumer computers 164 and 166, as well as the permission of the consumers to utilize the consumer computer and login to access retailer websites 152-156. Consumer service provider 72 causes webcrawlers 160-162 to be dispatched from consumer computers 164-166 and uses the consumer login to retailer websites 152-156 to access and request product information from retailers 66-70. Webcrawlers 160-162 collect the product information from retailer websites 152-156 through the consumer computer and login and return the product information to personal assistant engine 74 for storage within central database 76. The execution of webcrawlers 160-162 from consumer computers 164-166 distributes the computational work.

For example, the consumer logs into the website of consumer service provider 72 via webpage 136. Consumer service provider 72 initiates webcrawler 160 in the background of consumer computer 164 with a sufficiently low execution priority to avoid interfering with other tasks running on the computer. The consumer can also define the time of day and percent or amount of personal computer resources allocated to the webcrawler. The consumer can also define which retailer websites and products, e.g., by specific retailer, market, or geographic region, that can be accessed by the webcrawler using the personal computer resources. Webcrawler 160 executes from consumer computer 164 and uses the consumer's login to gain access to retailer websites 152-156. Alternatively, webcrawler 160 resides permanently on consumer computer 164 and runs periodically. Webcrawler 160 identifies products available from each of retailer websites 152-156 and requests pricing and other product information for each of the identified products. Webcrawler 160 navigates and parses each page of retailer websites 152-156 to locate pricing and other product information. The parsing operation involves identifying and recording product description, UPC, price, ingredients, size, and other product information as recovered by webcrawler 160 from retailer websites 152-156. In particular, the parsing operation can identify discounted offers and special pricing from retailers 66-70. The discounted pricing can be used in part to formulate individualized “one-to-one” discounted offers. The product information from retailer websites 152-156 is sorted and stored in central database 76.

Likewise, webcrawler 162 uses consumer computer 166 and login to gain access to retailer websites 152-156. Webcrawler 162 identifies products available from each of retailer websites 152-156 and requests pricing and other product information for each of the identified products. Webcrawler 162 navigates and parses each page of retailer websites 152-156 to locate pricing and other product information. The parsing operation involves identifying and recording product description, UPC, price, ingredients, size, and other product information as recovered by webcrawler 162 from retailer websites 152-156. In particular, the parsing operation can identify discounted offers and special pricing from retailers 66-70. The discounted pricing can be used in part to formulate individualized “one-to-one” discounted offers. The product information from retailer websites 152-156 is sorted and stored in central database 76. The product information can be specific to the consumer's login. Retailers 66-70 are likely to accept product information requests from webcrawlers 160-162 because the requests originate from consumer computers 164-166 by way of the consumer login to the retailer website.

Consumer service provider 72 can also collect product information from discounted offers transmitted from retailers 66-70 directly to consumers 62-64, e.g., by email or cell phone 116. Consumer 62-64 can make the personalized discounted offers and other product information available to consumer service provider 72.

Returning to FIG. 8, consumers 62 and 64 utilize consumer service provider 72 and personal assistant engine 74 to assist with the shopping process. In general, consumers 62 and 64 provide a list of products with weighted attributes. Personal assistant engine 74 generates an optimized shopping list 144, with discounted offers 145, from the list of consumer-weighted product attributes. The discounted offers 145 can include default discount offers and individualized discount offers. Consumers 62 and 64 use the optimized shopping list 144 and discounted offers 145 to patronize retailers 66-70. The transactions between consumers 62 and 64 and retailers 66-70, i.e., the actual purchasing decisions, are transmitted back to consumer service provider 72 by communication link 142 to evaluate the consumer's utilization of the optimized shopping list 144 and discounted offers 145.

Assume consumer 62 has logged-in to consumer service provider 72 through webpage 136. Consumer 62 is presented with a home page 170, as shown in FIG. 10, to launch a variety of operations and functions using one or more webpages. Block 172 shows the present consumer profile, including name, address, email address, and consumer photograph. The consumer can change personal information and otherwise update the profile in block 174. The consumer can access personal incentives and other offers in block 175. The consumer can define preferred retailers and shopping areas in block 176, and create and update one or more shopping lists in block 178.

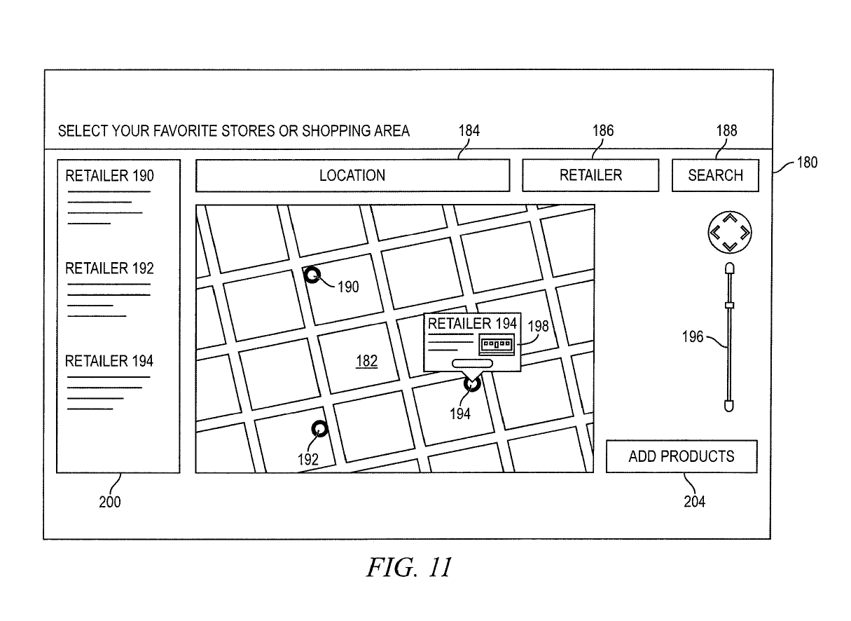

Under the define preferred retailers and shopping areas block 176, personal assistant engine 74 presents webpage 180 with a local map 182, as shown in FIG. 11. A location can be entered in block 184, and retailer name, retailer type, or retailer chain can be entered in block 186. Central database 76 contains the name, type, description, and location of retailers nationwide. Consumer 62 presses search button 188 to search central database 76 for local retailers according to the location and retailer search pattern in blocks 184-186. The local retailers 190, 192, and 194 matching the search criteria are displayed on map 182. The resolution of map 182 can be adjusted from street level view to a national view with sliding scale 196. Consumer 62 can view additional information about each retailer by hovering the mouse pointer over the retailer location identifier on map 182. For example, pop-up box 198 shows an image, address, phone number, retailer type, retailer website, operating hours, description, and consumer rating and comments of retailer 194. Webpage 180 can provide a button to select all retailers, types of retailers, retailers by tradename, or individual retailers. Consumer 62 searches for grocery retailers and selects retailers 190-194 that he or she would be willing to patronize by individually clicking on the retailer location identifiers 190-194 on map 182. An image, address, phone number, retailer type, retailer website, operating hours, description, and consumer rating and comments of the selected retailers 190-194 are displayed in block 200.

Consumer 62 can also specify all retailers or a selected group of retailers within a geographical shopping area with defined boundaries. The boundaries can be a city, zip code, named roadways, or given number of miles radius to the consumer's address. Consumer 62 can also draw a box on map 182 with the mouse to define the boundaries of the preferred geographical shopping area. The search for retailers would then be limited to the preferred geographical shopping area.

Once the preferred retailers 190-194 or geographical shopping areas are identified, consumer 62 clicks on add products button 204 to create a shopping list of products of interest or need with product attributes weighted by consumer preference. Consumer can also select block 178 in FIG. 10 to create or update a shopping list of products of interest or need with product attributes weighted by consumer preference.

Consumers can create a new shopping list or update an existing shopping list by entering, modifying, or deleting products through one or more webpages, or by mobile application. A plurality of shopping lists can be segregated by type of items, e.g., different shopping lists for food items, household items, apparel, books, and auto parts. A plurality of shopping lists can be segregated by household member, e.g., different shopping lists each spouse, child, or other member of the household. The shopping list can be aggregated for all items needed by the entire household. In webpage 210 of FIG. 12, personal assistant engine 74 presents link 212 to an existing shopping list for food items and link 214 to an existing shopping list for apparel, as well as link 216 to create a new shopping list. Consumer 62 selects a link to add, delete, or modify the shopping list.

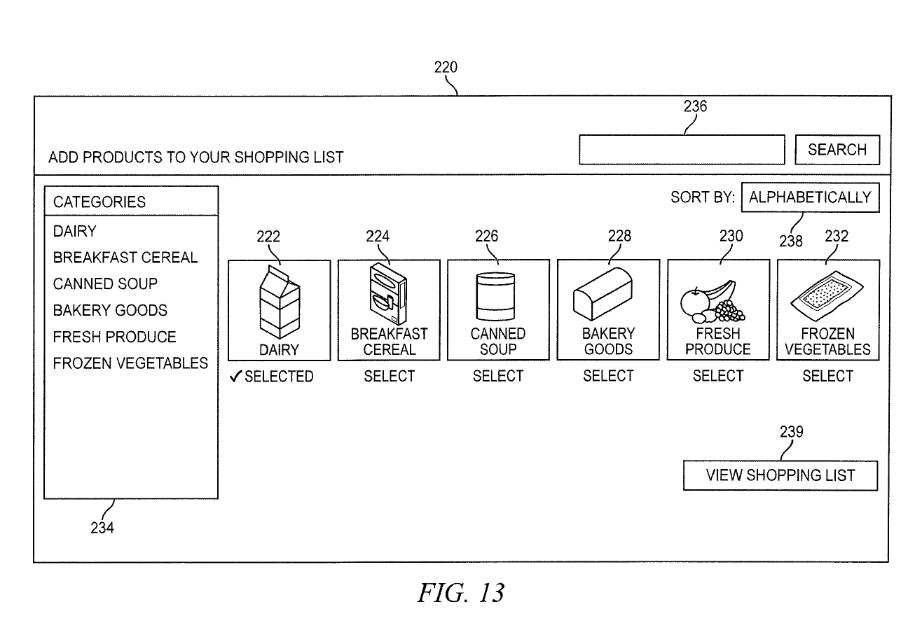

As an illustration of links 212-216, FIG. 13 shows webpage 220 presenting categories of food items. A category is presented for each type of food item. For example, block 222 with corresponding select button is presented for dairy products, block 224 with corresponding select button is presented for breakfast cereal, block 226 with corresponding select button is presented for canned soup, block 228 with corresponding select button is presented for bakery goods, block 230 with corresponding select button is presented for fresh produce, and block 232 with corresponding select button is presented for frozen vegetables. A list of categories of food items is also presented in block 234. Block 236 with adjacent search button enables consumer 62 to search for other categories or specific food items. Block 238 enables consumer 62 to sort the categories of food by cost, frequency of purchase, alphabetically, or other convenient attribute.

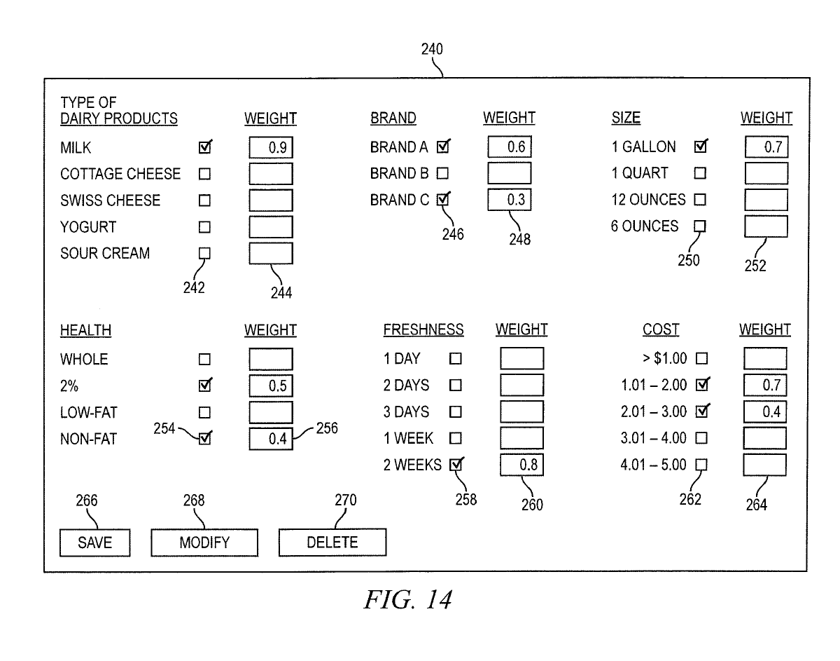

Consumer 62 clicks on the select button corresponding to a category of food item. In the present example, consumer 62 clicks the select button for block 222 to choose attributes and weighting factors or preference levels for dairy products. The available attributes for dairy products are presented in a pop-up window on webpage 220 or on a different webpage. FIG. 14 shows pop-up window 240 overlaying webpage 220 with attributes for type of dairy product, brand, size, health, freshness, and cost. Each attribute has an associated consumer-defined weighting factor for relative importance to the consumer. For example, the attributes for type of dairy product include milk, cottage cheese, Swiss cheese, yogurt, and sour cream. Consumer 62 can select one or more attributes under the type of dairy product by clicking on boxes 242. A checkmark appears in the box 242 selected by consumer 62. Consumer 62 can enter a weighting value or indicator in block 244 corresponding to the importance of the selected attribute. The weighting factor can be a numeric value, e.g., from 0.0 (lowest importance) to 0.9 (highest importance), “always”, “never”, or other designator meaningful to the consumer. Alternatively, block 244 includes a sliding scale to select a relative value for the weighting factor. The sliding scale adjusts the preference level of the product attribute by moving a pointer along the length of the sliding scale. The computer interface can be color coded or otherwise highlighted to assist with assigning a preference level for the product attribute. In the present pop-up window 240, consumer selects milk under type of dairy product and assigns a weighting factor of 0.9. Consumer 62 considers milk to be an important type of dairy product to be added to the shopping list.

In pop-up window 240, the attributes for brand include brand A, brand B, and brand C. A brand option is provided for each type of dairy product or for the selected type of dairy product. Consumer 62 can select one or more attributes under brand by clicking on boxes 246. A checkmark appears in the box 246 selected by consumer 62. Consumer 62 can enter a weighting value or indicator in block 248 corresponding to the importance of the selected attribute. The weighting factor can be a numeric value, e.g., 0.0-0.9. Alternatively, block 248 includes a sliding scale to select a relative value for the weighting factor. In the present pop-up window 240, consumer selects brand A with a weighting factor of 0.6 and brand C with a weighting factor of 0.3 for the selected milk attribute. Consumer 62 considers either brand A or brand C to be acceptable, but brand A is preferred over brand C as indicated by the relative weighting factors. The weighting factors associated with different brands allows consumer 62 to assign preference levels to acceptable brand substitutes.

The attributes for size include 1 gallon, 1 quart, 12 ounces, and 6 ounces. A size option is provided for each type of dairy product or for the selected type of dairy product. Consumer 62 can select one or more attributes under size by clicking on boxes 250. A checkmark appears in the box 250 selected by consumer 62. Consumer 62 can enter a weighting value or indicator in block 252 corresponding to the importance of the selected attribute. The weighting factor can be a numeric value, e.g., 0.0-0.9. In the present pop-up window 240, consumer selects 1 gallon with a weighting factor of 0.7 for the selected milk attribute.

The attributes for health include whole, 2%, low fat, and non-fat. A health option is provided for each type of dairy product or for the selected type of dairy product. Consumer 62 can select one or more attributes under health by clicking on boxes 254. A checkmark appears in the box 254 selected by consumer 62. Consumer 62 can enter a weighting value or indicator in block 256 corresponding to the importance of the selected attribute. The weighting factor can be a numeric value, e.g., 0.0-0.9. In the present pop-up window 240, consumer selects 2% with a weighting factor of 0.5 and non-fat with a weighting factor of 0.4 for the selected milk attribute. Consumer 62 considers either 2% milk or non-fat milk to be acceptable, but 2% milk is preferred over non-fat as indicated by the relative weighting factors. The weighting factors associated with different health attributes allows consumer 62 to assign preference levels to acceptable health attribute substitutes.

The attributes for freshness include 1 day old, 2 days old, 3 days old, 1 week to expiration, or 2 weeks to expiration. A freshness option is provided for each type of dairy product or for the selected type of dairy product. Consumer 62 can select one or more attributes under freshness by clicking on boxes 258. A checkmark appears in the box 258 selected by consumer 62. Consumer 62 can enter a weighting value or indicator in block 260 corresponding to the importance of the selected attribute. The weighting factor can be a numeric value, e.g., 0.0-0.9. In the present pop-up window 240, consumer selects 2 weeks to expiration with a weighting factor of 0.8 for the selected milk attribute.

The attributes for cost include less than $1.00, $1.01-2.00, $2.01-3.00, $3.01-4.00, or $4.01-5.00. Consumer 62 can select one or more attributes under cost by clicking on boxes 262. A checkmark appears in the box 262 selected by consumer 62. Consumer 62 can enter a weighting value or indicator in block 264 corresponding to the importance of the selected attribute. The weighting factor can be a numeric value, e.g., 0.0-0.9. In the present pop-up window 240, consumer selects $1.01-2.00 with a weighting factor of 0.7 and $2.01-3.00 with a weighting factor of 0.4 for the selected milk attribute. Consumer 62 is willing to pay either $1.01-2.00 or $2.01-3.00, but would prefer to pay $1.01-2.00 as indicated by the relative weighting factors.

Once the consumer-defined attributes and weighting factors for milk are selected, consumer 62 clicks on save button 266 to record the configuration in central database 76. The consumer-defined attributes and weighting factors for milk can be modified with modify button 268 or deleted with delete button 270 in pop-up window 240.

Consumer 62 can add, delete, or modify additional types of dairy products, such as cottage cheese, Swiss cheese, yogurt, and sour cream, in a similar manner as described for milk in FIG. 14. For each type of dairy product, consumer 62 selects one or more brand attributes and associated weighting factors, size attributes and weighting factors, health attributes and weighting factors, freshness attributes and weighting factors, and cost attributes and weighting factors. For each type of dairy product, consumer 62 clicks on save button 266 to record the weighted attribute configuration in central database 76. Consumer 62 can also click on modify button 268 or delete button 270 to change or cancel a previously entered product configuration.

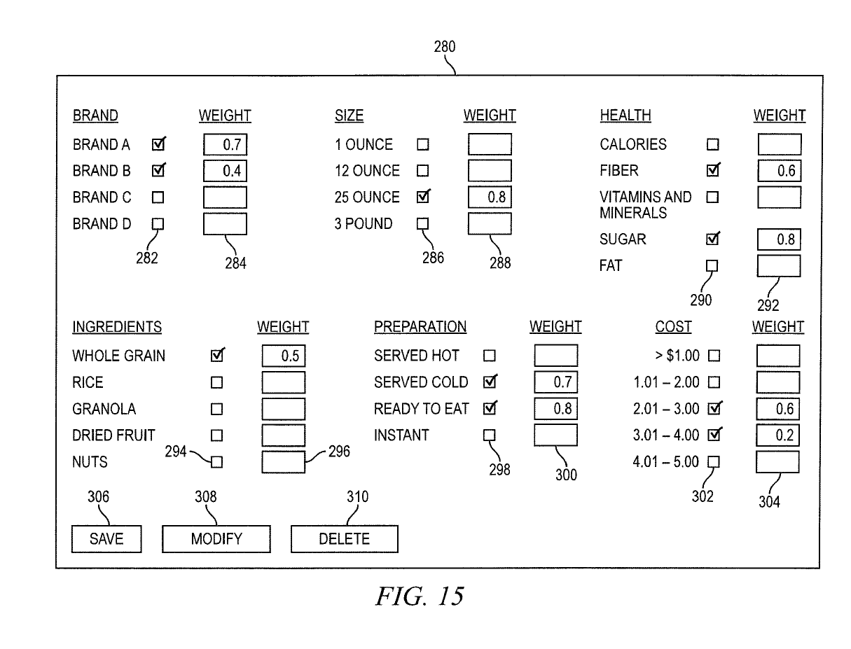

Once the attributes and weighting factors for all dairy products are defined by consumer preference, consumer 62 returns to FIG. 13 to make selections for the next product category. In the present example, consumer 62 clicks the select button for block 224 to choose attributes and weighting factors for breakfast cereal. The available attributes for breakfast cereal products are presented in a pop-up window on webpage 220 or on a different webpage. FIG. 15 shows pop-up window 280 overlaying webpage 220 with attributes for brand, size, health, ingredients, preparation, and cost. Each attribute has an associated consumer-defined weighting factor for relative importance to the consumer. For example, the attributes for brand include brand A, brand B, brand C, and brand D. Consumer 62 can select one or more attributes under brand by clicking on boxes 282. A checkmark appears in the box 282 as selected by consumer 62. Consumer 62 can enter a weighting value or indicator in block 284 corresponding to the importance of the selected attribute. The weighting factor can be a numeric value, e.g., from 0.0 (lowest importance) to 0.9 (highest importance), “always”, “never”, or other designator meaningful to the consumer. Alternatively, block 284 includes a sliding scale to select a relative value for the weighting factor. The sliding scale adjusts the preference level of the product attribute by moving a pointer along the length of the sliding scale. The computer interface can be color coded or otherwise highlighted to assist with assigning a preference level for the product attribute. In the present pop-up window 280, consumer selects brand A with a weighting factor of 0.7 and brand B with a weighting factor of 0.4 for the selected brand attribute. Consumer 62 considers either brand A or brand B to be acceptable, but brand A is preferred over brand B as indicated by the relative weighting factors. The weighting factors associated with different brands allow consumer 62 to assign preference levels to acceptable brand substitutes.

The attributes for size include 1 ounce, 12 ounce, 25 ounce, and 3 pound. Consumer 62 can select one or more attributes under size by clicking on boxes 286. A checkmark appears in the box 286 selected by consumer 62. Consumer 62 can enter a weighting value or indicator in block 288 corresponding to the importance of the selected attribute. The weighting factor can be a numeric value, e.g., 0.0-0.9. In the present pop-up window 280, consumer selects 25 ounce size with a weighting factor of 0.8.

The attributes for health include calories, fiber, vitamins and minerals, sugar content, and fat content. Health attributes can be given in numeric ranges. Consumer 62 can select one or more attributes under health by clicking on boxes 290. A checkmark appears in the box 290 selected by consumer 62. Consumer 62 can enter a weighting value or indicator in block 292 corresponding to the importance of the selected attribute. The weighting factor can be a numeric value, e.g., 0.0-0.9. In the present pop-up window 280, consumer selects fiber with a weighting factor of 0.6 and sugar content with a weighting factor of 0.8. Consumer 62 considers fiber and sugar content with numeric ranges to be important nutritional attributes according to the relative weighting factors.

The attributes for ingredients include whole grain, rice, granola, dried fruit, and nuts. Consumer 62 can select one or more attributes under ingredients by clicking on boxes 294. A checkmark appears in the box 294 selected by consumer 62. Consumer 62 can enter a weighting value or indicator in block 296 corresponding to the importance of the selected attribute. The weighting factor can be a numeric value, e.g., 0.0-0.9. In the present pop-up window 280, consumer selects whole grain with a weighting factor of 0.5.

The attributes for preparation include served hot, served cold, ready-to-eat, and instant. Consumer 62 can select one or more attributes under preparation by clicking on boxes 298. A checkmark appears in the box 298 selected by consumer 62. Consumer 62 can enter a weighting value or indicator in block 300 corresponding to the importance of the selected attribute. The weighting factor can be a numeric value, e.g., 0.0-0.9. In the present pop-up window 280, consumer selects served cold with a weighting factor of 0.7 and ready-to-eat with a weighting factor of 0.8.

The attributes for cost include less than $1.00, $1.01-2.00, $2.01-3.00, $3.01-4.00, or $4.01-5.00. Consumer 62 can select one or more attributes under cost by clicking on boxes 302. A checkmark appears in the box 302 selected by consumer 62. Consumer 62 can enter a weighting value or indicator in block 304 corresponding to the importance of the selected attribute. The weighting factor can be a numeric value, e.g., 0.0-0.9. In the present pop-up window 280, consumer selects $2.01-3.00 with a weighting factor of 0.6 and $3.01-4.00 with a weighting factor of 0.2. Consumer 62 is willing to pay either $2.01-3.00 or $3.01-4.00, but would prefer to pay $2.01-3.00 as indicated by the relative weighting factors.

Once the consumer-defined attributes and weighting factors for breakfast cereal are selected, consumer 62 clicks on save button 306 to record the configuration in central database 76. The consumer-defined attributes and weighting factors for breakfast cereal can be modified with modify button 308 or deleted with delete button 310 in pop-up window 280.

Consumer 62 can add, delete, or modify other breakfast cereals in a similar manner as described in FIG. 15. For each breakfast cereal, consumer 62 selects one or more brand attributes and associated weighting factors, size attributes and weighting factors, health attributes and weighting factors, ingredients attributes and weighting factors, preparation attributes and weighting factors, and cost attributes and weighting factors. For each breakfast cereal, consumer 62 clicks on save button 306 to record the weighted attribute configuration in central database 76. Consumer 62 can also click on modify button 308 or delete button 310 to change or cancel a previously entered product configuration.

Consumer 62 makes selections of attributes and weighting factors canned soup in block 226, bakery goods in block 228, fresh produce in block 230, and frozen vegetables in block 232, as well as other food categories, in a similar manner as described in FIGS. 14 and 15. The food categories can also be selected from block 234 in FIG. 13. The consumer-defined product attributes and weighting factors for each food category are stored in central database 76. The attributes and weighting factors as selected by consumer 62 in each of the food categories constitute an initial or generally defined list of products of interest or need by the consumer.

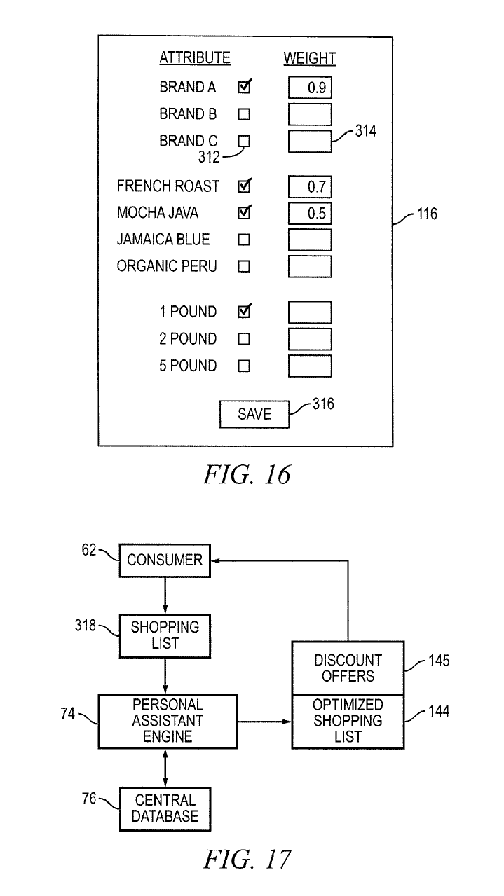

In another embodiment, consumer 62 can record product attributes and weighting factors by mobile application. When patronizing a retailer, consumer 62 can record a product of interest or need by scanning the UPC on the shelf or product itself with cell phone 116. The UPC is transmitted to consumer service provider 72 and decoded. The product attributes are retrieved from central database 76, transmitted back to consumer 62, and displayed on cell phone 116. For example, if consumer 62 scans a particular ground coffee, the UPC identifies it as brand A, French roast flavor, and 1 pound size for the ground coffee, as shown in FIG. 16. Personal assistant engine 74 provides other ground coffee attributes, e.g., other brands, flavors, and sizes. Consumer 62 can select product attributes by clicking on boxes 312, i.e., to indicate a willingness to consider similar products, and assign weighting factors for the product attributes in boxes 314. Consumer 62 selects brand A and assigns a weighting factor. Consumer 62 also changes the attributes to accept French roast and mocha Java flavors with corresponding weighting factors. No weight is assigned to the size attribute. The product attributes and weighting factors are transmitted back to consumer service provider 72 and stored in central database 76 to update the consumer's shopping list by clicking on save button 316. The mobile application on cell phone 116 can also decode the UPC.

Many cell phones 116 contain a global positioning system (GPS) device to identify the exact location of consumer 62 while in the premises of a retailer. Knowledge of the present location of consumer 62 provides a number of advantages. For example, consumer service provider 72 can give directions to consumer 62 of the shelf location of each product on the optimized shopping list 144. With RF ID tag attached to products, cell phone 116 can display directional information such as text or arrows to guide consumer 62 to the product location. Many retailers also offer in-store locator systems in communication with cell phone 116 to assist with finding specific products.

In FIG. 17, personal assistant engine 74 stores shopping list and weighted product attributes 318 of each specific consumer in central database 76 for future reference and updating. Personal assistant engine 74 can also store prices, product descriptions, names and locations of the retail stores selling the products, offer histories, purchase histories, as well as various rules, policies and algorithms. The individual products in the shopping list can be added or deleted and the weighted product attributes can be changed by the consumer. The shopping list entered into personal assistant engine 74 is specific for each consumer and allows consumer service provider 72 to track specific products and preferred retailers selected by the consumer.

The consumer can also identify a specific preferred retailer as an attribute with an assigned preference level based on convenience and personal experience. The consumer may assign value to shopping with a specific retailer because of specific products offered by that store, familiarity with the store layout, good consumer service experiences, or location that is convenient on the way home from work, picking up the children from school, or routine weekend errand route.

Given the consumer-generated initial list of products 318 as defined in FIGS. 13-16, personal assistant engine 74 executes a consumer model or comparative shopping service to optimize the shopping list and determine which products should be purchased from which retailers on which day to maximize the value to the consumer as defined by the consumer profile and list of products of interest with weighted attributes. Personal assistant engine 74 also generates for each specific consumer an optimized shopping list 144 with discounted offers 145, as shown in FIGS. 8 and 17, by considering each line item of the consumer's shopping list 318 from webpage 220 and pop-up windows 240 and 280 and reviewing retailer product information in central database 76 to determine how to best align each item to be purchased with the available products from the retailers. For example, consumer 62 wants to purchase dairy products and has provided shopping list 318 with preference levels for weighted product attributes for milk and other dairy products that are important to his or her purchasing decision. Central database 76 contains dairy product descriptions, dairy product attributes, and pricing for each retailer 190-194. Personal assistant engine 74 reviews the attributes of dairy products offered by each retailer 190-194, as stored in central database 76. The more specific the consumer-defined attributes, the narrower the search field but more likely the consumer will get the preferred product. The less specific the consumer-defined attributes, the wider the search field and more likely the consumer will get the most choices and best pricing.

The product attributes of each dairy product for retailers 190-194 in central database 76 are compared to the consumer-defined weighted product attributes in shopping list 318 by personal assistant engine 74. For example, the available dairy products from retailer 190 are retrieved and compared to the weighted attributes of consumer 62. Likewise, the available dairy products from retailer 192 are retrieved and compared to the weighted attributes of consumer 62, and the available dairy products from retailer 194 are retrieved and compared to the weighted attributes of consumer 62. Consumer 62 wants milk under brand A with weighting level of 0.6 or milk under brand C with a weighting level of 0.3. The retailers with brand A of milk or brand C of milk receive credit or points weighted by the preference level for meeting the consumer's attribute. Otherwise, the retailers receive no credit or points, or less credit or points, because the product attribute does not align or is less aligned with the consumer-weighted attribute. Consumer 62 wants 1 gallon size with a preference level of 0.7. The retailers with 1 gallon size milk receive credit or points weighted by the preference level for meeting the consumer's attribute. Otherwise, the retailers receive no credit or points, or less credit or points, because the product attribute does not align or is less aligned with the consumer-weighted attribute. Consumer 62 wants 2% milk with a preference level of 0.5 or non-fat milk with a preference level of 0.4. The retailers with 2% milk or non-fat milk receive credit or points weighted by the preference level for meeting the consumer's attribute. Otherwise, the retailers receive no credit or points, or less credit or points, because the product attribute does not align or is less aligned with the consumer-weighted attribute. Consumer 62 wants 2 weeks to expiration for milk with a preference level of 0.8. The retailers with fresh milk (at least 2 weeks to expiration) receive credit or points weighted by the preference level for meeting the consumer's attribute. The retailers with milk set to expire in less than 2 weeks receive less credit or points because the product attribute does not align or is less aligned with the consumer-weighted attribute. Consumer 62 wants milk at a price $1.01-2.00 with a preference level of 0.7, or milk at a price $2.01-3.00 with a preference level of 0.4. The retailers with the lower net price (regular price minus discount for consumer 62) receive the most credit or points weighted by the preference level for being the closest to meeting the consumer's attribute. The retailers with higher net prices receive less credit or points because the product attribute does not align or is less aligned with the consumer-weighted attribute.

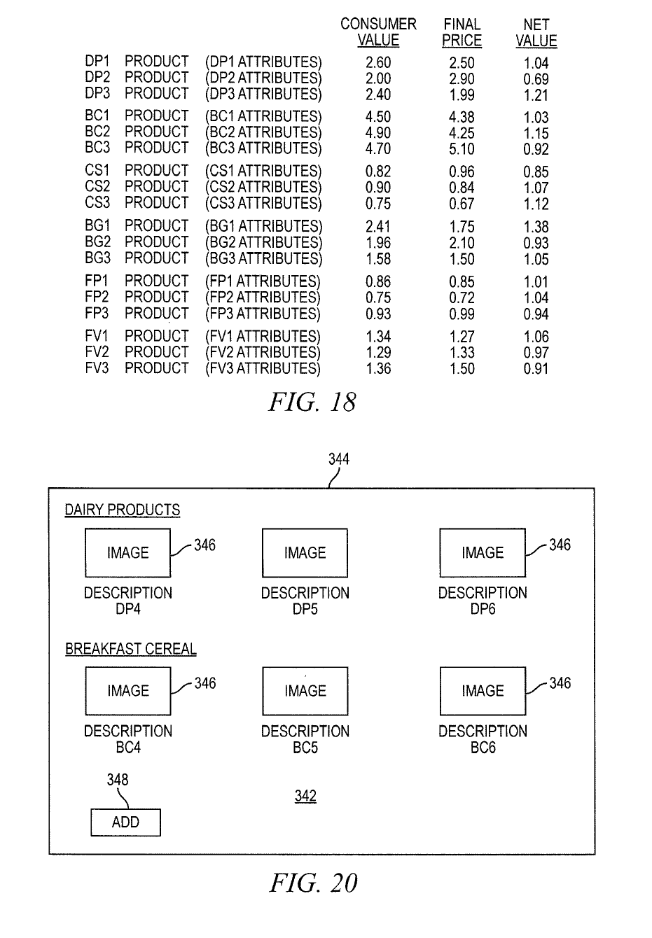

FIG. 18 shows three possible choices for the consumer requested dairy product (milk) from retailers 190-194, as ascertained from central database 76. Dairy product DP1 from retailer 190 is shown with DP1 product attributes, e.g., brand A, 1 gallon, 2%, 2 weeks to expiration freshness, and discounted price of $2.50 (regular price of $2.90 less 0.40 default discounted offer from retailer 190). The “Consumer Value” column shows the value to consumer 62 based on alignment of the DP1 product attributes and the weighted product attributes as defined by the consumer. The DP1 product gets attributes points AP1 for brand A, attributes points AP2 for 1 gallon, attributes points AP3 for 2%, attributes points AP4 for 2 weeks to expiration freshness, and attributes points AP5 for discounted price of $2.50. The consumer value (CV) is summation of assigned attributes points for alignment between the product attributes and the weighted product attributes as defined by the consumer times the preference level for the weighted product attributes, i.e., AP1*0.6+AP2*0.7+AP3*0.5+AP4*0.8+AP5*0.4. Assume that the DP1 product gets CV of $2.60 USD. The consumer value CV is given in a recognized monetary denomination, such as US dollar (USD), Canadian dollar, Australian dollar, Euro, British pound, Deutsche mark, Japanese yen, and Chinese yuan.

Consumer value CV can also be determined by equation (1) as follows:

CV=CV_{b}Πₐ(Mₐ) (1)

where:
CV_{b} is a baseline product value of the product category, and
Mₐ is the product attribute value to the consumer for product attribute a expressed as (1+x %), where
x is a percentage increase in value of the product to the consumer having the attribute a with respect to products having no product attribute a.

The “Final Price” column shows the final price (FP) offered to the consumer, i.e., regular price less the default discount from retailer 190 ($2.90−0.40=2.50). The “Net Value” column is the net value or normalized value (NV) of the DP1 product to consumer 62. In one embodiment, the net value is the consumer value normalized by the final price, i.e., NV=CV/FP. Alternatively, the net value is determined by NV=(CV−FP)/CV. Using the first normalizing definition, NV=2.60/2.50=1.04. The consumer value CV is greater than the final price FP offered by retailer 190, including the default discount. The net value NV to consumer 62 is greater than one (CV greater than FP) so the DP1 product is a possible choice for the consumer. Using the second normalizing definition, NV=(2.60−2.50)/2.60=+0.04. The net value NV to consumer 62 is positive so the DP1 product may be a good choice for the consumer. Consumer 62 is likely to buy the DP1 product because the product attributes align or match reasonably well with the consumer weighted attributes, taking into account the discounted offer. A net value NV greater than one or positive indicates that retailer 190 may receive a positive purchasing decision from consumer 62 because the consumer value CV greater than the final price FP. Personal assistant engine 74 may recommend the DP2 product to consumer 62 in optimized shopping list 144.

Dairy product DP2 (milk) from retailer 192 is shown with DP2 product attributes, e.g., brand B, 1 gallon, non-fat, 1 week to expiration in freshness, and pricing of $2.90 (regular price of $2.90 with no discounted offer from retailer 192). The DP2 product gets no or minimal attributes points AP6 for brand B, attributes points AP7 for 1 gallon size, attribute points AP8 for non-fat, no or minimal attribute points AP9 for 1 week to expiration in freshness, and attributes points AP10 for the $2.90 price. The consumer value is AP7*0.7+AP8*0.4+AP10*0.4. Assume that the DP2 product gets CV of $2.00 USD. The final price FP is the regular price less the default discount from retailer 192 ($2.90). Using the first normalizing definition, NV=2.00/2.90=0.69. The net value NV to consumer 62 is less than one so the DP2 product will not be a good choice for the consumer. Using the second normalizing definition, NV=(2.00−2.90)/2.00=−0.45. The net value NV to consumer 62 is negative so the DP2 product will not be a good choice for the consumer. Consumer 62 is likely not to buy the DP2 product because the product attributes do not align or match well with the consumer weighted attributes, taking into account the discounted offer. A net value NV less than one or negative indicates that retailer 190 would likely not receive a positive purchasing decision from consumer 62. Personal assistant engine 74 should not recommend the DP2 product to consumer 62 in optimized shopping list 144.

Dairy product DP3 (milk) from retailer 194 is shown with DP3 product attributes, e.g., brand C, 1 gallon size, 2%, 2 weeks to expiration in freshness, and pricing of $1.99 (regular price of $2.75 less 0.76 discounted offer from retailer 194). The DP3 product gets attributes points AP11 for brand C, attributes points AP12 for 1 gallon size, attributes points AP13 for 2%, attributes points AP14 for 2 weeks to expiration in freshness, and attributes points AP15 for the $1.99 price. The consumer value is AP11*0.3+AP12*0.7+AP13*0.5+AP14*0.8+AP15*0.7. Assume that the DP3 product gets CV of $2.40 USD. The final price FP is the regular price less the default discount ($2.75−0.76=1.99). Using the first normalizing definition, NV=2.40/1.99=1.21. The net value NV to consumer 62 is greater than one (CV greater than FP) so the DP3 product is a possible choice for consumer 62. Using the second normalizing definition, NV=(2.40−1.99)/2.40=+0.17. The net value NV to consumer 62 is positive so the DP3 product is a possible choice for the consumer. In fact, based on the default discounted offers from retailers 190-194, the net value of the DP3 product (NV=1.21) or (NV=+0.17) is the highest net value NV, i.e., higher than the net value of the DP1 product (NV=1.04) or (NV=+0.04) and higher than the net value of the DP2 product (NV=0.69) or (NV=−0.45). The DP3 product is placed on optimized shopping list 144. The DP3 product is the optimal choice for consumer 62 in that if the consumer needs to purchase milk, then DP3 is the product most closely aligned with the consumer weighted attributes, i.e., highest net value NV, and would likely receive a positive purchasing decision from consumer 62.

The above process is repeated for breakfast cereal products BC1, BC2, and BC3, canned soup brands CS1, CS2, and CS3, bakery goods BG1, BG2, and BG3, fresh produce FP1, FP2, and FP3, and frozen vegetables FV1, FV2, and FV3 from webpage 220 and pop-up windows 240 and 280 based on the product information in central database 76, preference levels for the consumer weighted product attributes, and lowest discount that will result in a positive purchasing decision. The best value product in each food category for consumer 62 is placed on optimized shopping list 144. In the present example, the BC2 product from retailer 192 (NV=1.15), the CS3 product from retailer 194 (NV=1.12), the BG1 product from retailer 190 (NV=1.38), the FP2 product from retailer 192 (NV=1.04), and the FV1 product from retailer 190 (NV=1.06) are determined to be the best value product brand for consumer 62 and are placed on optimized shopping list 144. The other products from retailers 190-194 had a net value less than one or a net value greater than one but less than that of the winning retailer.

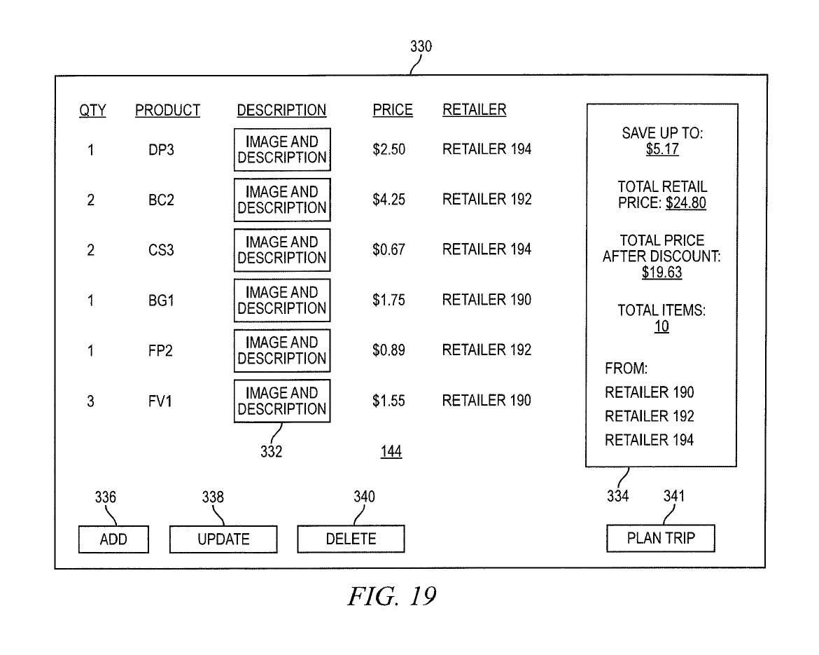

Consumer 62 can view the optimized shopping list 144 by clicking on the view shopping list button 239 in FIG. 13. The optimized shopping list 144 is presented to consumer 62 on webpage 330 in FIG. 19. The optimized shopping list 144 includes products selected by personal assistant engine 74 based on the consumer weighted product attributes and product information from retailers 190-194 in central database 76. The highest NV product for items in each food category are displayed with quantity, product name, description field, price, and retailer. According to the above analysis, DP3 (milk) is presented with quantity 1, image and detailed description of DP3 in block 332, price, and retailer, as having the highest NV to consumer 62. The image and description of DP3 include a photo, package size, package configuration, availability, highest price at any retailer, lowest price at any retailer, average price, discount offer, and other marketing information. Likewise, BC2 is presented with quantity 2, image and detailed description of BC2 in block 332, price, and retailer; CS3 is presented with quantity 2, image and detailed description of CS3 in block 332, price, and retailer; BG1 is presented with quantity 1, image and detailed description of BG1 in block 332, price, and retailer; FP2 is presented with quantity 1, image and detailed description of FP2 in block 332, price, and retailer; and FV1 is presented with quantity 3, image and detailed description of FV1 in block 332, price, and retailer. The optimized shopping list 144 can be presented in a grid arrangement or scrolling vertical or horizontal banner. For each item in optimized shopping list 144 on webpage 330, additional consumer information can be displayed such as price history, health benefits, suggested for season, time to stock up before price increase, and other consumer tips. The image and description field can be enlarged with a pop-up window to show product ingredients, health warnings, manufacturer, and nutrition label.

Webpage 330 also displays in block 334 a “save up to” price of $5.17 as retail price less discounts, total retail price of $24.80, and total price after discounts of $19.63 for all 10 items. The “save up to” value can be based on actual pricing of the retailer or an average or highest local, regional, or national regular pricing. For example, the “save up to” value can be the highest price from any retailer in a region over the past year. A list of the retailers to be patronized (190-194) is also shown in block 334, based on the products contained in the optimized shopping list 144. Webpage 330 also provides options to show the consumer weighted product attributes in a pop-up window, similar to FIGS. 14 and 15, by clicking on any image and description block 332. The optimized shopping list 144 can be sorted or organized by cost, frequency of purchase, aisle or location with the retailer, alphabetically, or other convenient attribute. Consumer 62 can modify the optimized shopping list 144, as well as the consumer weighted product attributes, with add button 336, update button 338, or delete button 340.

Webpage 330 can present alternate or additional versions of the optimized shopping list 144. For example, personal assistant engine 74 can generate a shopping list 342, as shown on webpage 344 of FIG. 20, with the best price, best deal, or other marking strategy for products across the board, or within one or more food categories. The best deal shopping list 342 can be based on the consumer weighted product attributes, or independent of the consumer weighted product attributes. Webpage 344 shows an image in block 346 and description field for best deal dairy products DP4, DP5, and DP6, and best deal breakfast cereals BC4, BC5, and BC6. The description field can contain product name, product size, packaging configuration, availability, highest price at any retailer, lowest price at any retailer, average price, retailer, retail price, discount, discounted price, and other marketing information. The image and description field of each best deal product can be enlarged with a pop-up window. The best deal products on shopping list 342 can be added to optimized shopping list 144 with add button 348.

In another embodiment, personal assistant engine 74 can generate an optimized shopping list, similar to FIG. 19, based on historical shopping practices of consumer 62. Personal assistant engine 74 can suggest additional products for an existing optimized shopping list 144 based on historical purchasing patterns of consumer 62. If consumer 62 historically purchases laundry detergent once a month and the item is not on optimized shopping list 144 after more than a month since the last purchase, then personal assistant engine 74 can suggest that laundry detergent be added to the list. Personal assistant engine 74 can generate an optimized shopping list based on favorite products of consumer 62.

In another embodiment, multiple brands and/or retailers for a single product can be placed on optimized shopping list 144. Personal assistant engine 74 can place, say the top two or top three net value brands and/or retailers on optimized shopping list 144, and allow the consumer to make the final selection and purchasing decision. In the above example, the DP3 product (NV=1.21) could be placed in first position on optimized shopping list 144 and the DP1 product (NV=1.04) would be in second position on the optimized shopping list.

Another optimized shopping list 144 is generated for consumer 64 by repeating the above process using the preference levels for the weighted product attributes as defined by consumer 64. The optimized shopping list 144 for consumer 64 gives the consumer the ability to evaluate one or more recommended products, each with a discount for consumer 64 to make a positive purchasing decision. The recommended products are objectively and analytically selected from a myriad of possible products from competing retailers according to the consumer weighted attributes. Consumers 62-64 will develop confidence in making a good decision to purchase a particular product from a particular retailer.

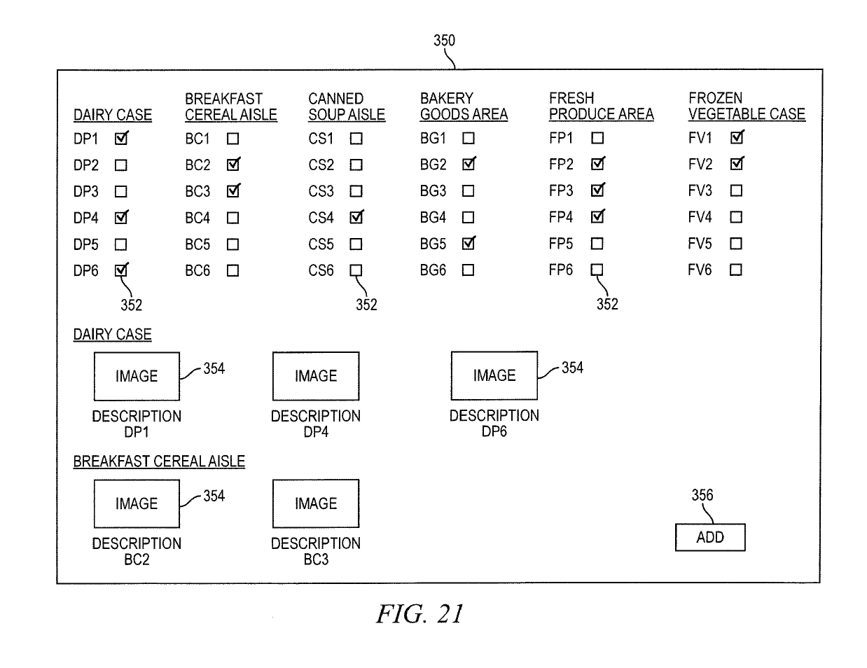

Personal assistant engine 74 can provide a virtual shopping experience for consumer 62. Retailers 190-194 each have a physical layout of the premise with aisles, shelves, end caps, walls, floor displays, dairy cases, wine and spirit cases, frozen cases, meat counters, deli counters, bakery area, fresh produce area, prepared foods counters, and check-out displays. While the specific location of each food area within any given store may differ between retailers, each retailer offers similar products arranged in a logical layout, e.g., dairy products are stocked in the same general area, frozen foods are stocked in the same general area, and so on. FIG. 21 shows webpage 350 with a virtual layout of one or more retailers with virtual aisles or cases for each category of food product. The virtual dairy case presents all dairy products, i.e., DP1-DP6, for the retailer. The virtual breakfast cereal aisle presents all breakfast cereal products, i.e., BC1-BC6, for the retailer. The virtual canned soup aisle presents all canned soup products, i.e., CS1-CS6, for the retailer. The virtual bakery goods area presents all bakery goods, i.e., BG1-BG6, for the retailer. The virtual fresh produce area presents all fresh produce products, i.e., FP1-FP6, for the retailer. The virtual frozen vegetable case presents all frozen vegetable products, i.e., FV1-FV6, for the retailer. Consumer 62 can select products from the virtual layout by clicking on box 352. The selected products are displayed for each food category with an image in block 354 and description field. The description field can contain product name, product size, packaging configuration, availability, highest price at any retailer, lowest price at any retailer, average price, retailer, retail price, discount, discounted price, and other marketing information. The selected products can be added to optimized shopping list 144 with add button 356.

In the business transactions between consumers 62-64 and retailers 190-194, consumer service provider 72 plays an important role in terms of increasing sales for the retailer, while providing the consumer with the most value for the money, i.e., creating a win-win scenario. More specifically, consumer service provider 72 operates as an intermediary between special offers and discounts made available by the retailer and distribution of those offers to the consumers.

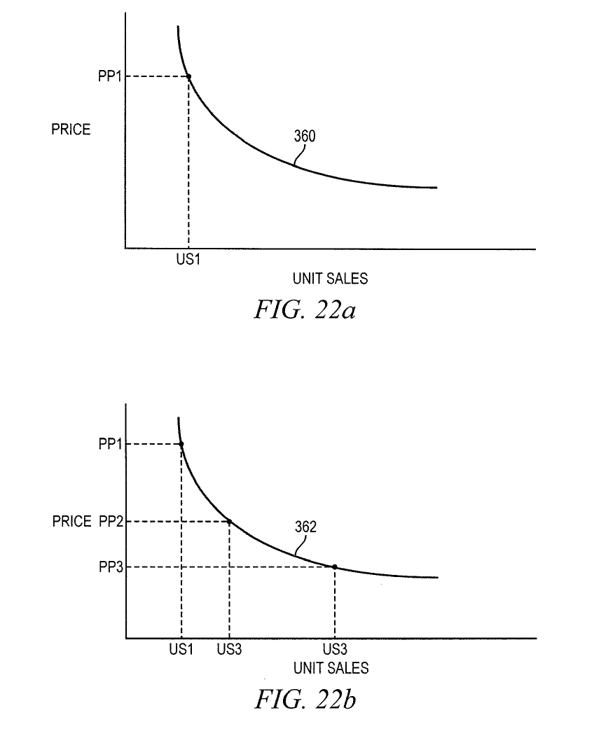

To explain part of the role of consumer service provider 72, first consider demand curve 360 of price versus unit sales, as shown in FIG. 22a. In demand curve 360 for a given product P, as price increases, unit sales decrease and, conversely, as price decreases, unit sales increase. At price point PP1, the unit sales are US1. The revenue attained by the retailer is given as PP1*US1. Thus, using a conventional mass marketing strategy as described in the background, if the retailer offers an across the board discounted offer or sale price PP1 to all consumers, e.g., via a newspaper advertisement, then, according to demand curve 360, the expected unit sales will be US1 and the retailer revenue is PP1*US1. That is, the consumers with a purchasing decision threshold of PP1 will buy product P and the consumers with a purchasing decision threshold less than PP1 will not buy product P. The conventional mass marketing approach has missed the opportunity to sell product P at price points below PP1. The retailer loses potential revenue that could have been earned at lower price points.

Now consider demand curve 362 in FIG. 22b with multiple price points PP1, PP2, and PP3, each capable of generating a profit for the retailer. The number of price points that can be assigned on demand curve 362 differ by as little as one cent, or a fraction of a cent. With a consumer targeted marketing approach, the consumers with a purchasing decision threshold of PP1 will buy product P at that price, the consumers with a purchasing decision threshold of PP2 will buy product P at that price, and the consumers with a purchasing decision threshold of PP3 will buy product P at that price. The retailer now has the potential revenue of PP1*US1+PP2*US2+PP3*US3. Although the profit margins for price points PP2 and PP3 are less than price point PP1, the unit sales US2 and US3 will be greater than unit sales US1. The total revenue for the retailer under FIG. 22b is greater than the revenue under FIG. 22a.

Under the consumer targeted marketing approach, each individual consumer receives a price point with an individualized discounted offer, i.e., PP1, PP2, or PP3, from the retailer for the purchase of product P. The individualized discounted offer is set according to the individual consumer price threshold that will trigger a positive purchasing decision for product P. The task is to determine an optimal pricing threshold for product P associated with each individual consumer and then make that discounted offer available for the individual consumer in order to trigger a positive purchasing decision. In other words, the individualized discounted offer involves consumer C1 being offered price PP1, consumer C2 being offered price PP2, and consumer C3 being offered price PP3 for product P. Each consumer C1-C3 should make the decision to purchase product P, albeit, each with a separate price point set by an individualized discounted offer. Consumer service provider 72 makes possible the individual consumer targeted marketing with the consumer-specific, personalized “one-to-one” offers as a more effective approach for retailers to maximize revenue as compared to the same discounted price for every consumer under mass marketing. Consumer service provider 72 becomes the preferred source of retail information for the consumer, i.e., an aggregator of retailers capable of providing one-stop shopping for many purchasing options. The individualized discounted offers enable market segmentation to the “one-to-one” level with each individual consumer receiving personalized pricing for a specific product.

With respect to pricing, each retailer has two price components: regular price and discounted offers from the regular price that are variable over time and specific to each consumer. The net price to consumer 62 is the regular price less the individualized discounted offer for that consumer. To determine optimal individualized discount needed to achieve a positive consumer purchasing decision for product P from consumer 62, personal assistant engine 74 considers the individualized discounts from each retailer 190-194. In one embodiment, the individualized discount can be a default discount determined by the retailer or personal assistant engine 74 on behalf of the retailer. The default discount is defined to provide a reasonable profit for the retailer as well as reasonable likelihood of attaining the first position on optimized shopping list 144, i.e., the default discounted offer is selected to be competitive with respect to other retailers.

Personal assistant engine 74 generates for each specific consumer an individualized discounted offer 145 for each product on optimized shopping list 144, as shown in FIGS. 8 and 17. The individualized discounted offer is crafted for each individual consumer based on a product specific preference value of the consumer weighted attributes. Each consumer receives an individualized “one-to-one” offer 145. That is, the optimized shopping list for consumer 62 will have an individualized discounted offer 145 for product P1 based on the product specific preference value of the consumer 62 weighted attributes. The optimized shopping list for consumer 64 may have a different individualized discounted offer 145 for the same product P1 based on the product specific preference value of the consumer 64 weighted attributes. The individualized discounted offer 145 should be set to trigger a positive purchasing decision for each consumer. The products that show up on optimized shopping list 144 are the products of interest to the consumer offered at the most valued price.

The optimal discounted offer tipping point (P_{TIP}) for consumer 62 to make a positive purchasing decision between two products can be determined according to P_{TIP}=CV_{K}−CV_{K}*(CV_{I}−P_{I})/CV_{I}, where CV_{K} is the consumer value of product K, CV_{I} is the consumer value of product I, and P_{I} is the price of product I.

Retailers 190-194 do not necessarily want to offer every consumer 62-64 the maximum retailer acceptable discount as that would minimize profit for the retailer. Personal assistant engine 74 must determine the price tipping point for consumer 62 to make a positive purchasing decision, i.e., the lowest individualized discounted price that would entice the consumer to purchase one product. Any product with a net value less than one or negative net value given the maximum retailer acceptable discount is eliminated because there is no practical discount, i.e., a discount that still yields a profit for the retailer, that the retailer could offer which would entice consumer 62 to purchase the product. As for the other products, personal assistant engine 74 incrementally modifies the individualized discounted offer to a value less than the maximum retailer acceptable discount, i.e., raises the final price FP (regular price minus the individualized discount) to consumer 62. The modified individualized discounted offer can be a lesser incremental discount, e.g., the default discount or as little as one cent or fraction of one cent less than the maximum retailer acceptable discount. Personal assistant engine 74 recalculates the net value NV for consumer 62, as described above, for each of the remaining DP1-DP3 products (except for eliminated products) at the modified final price point. Based on the modified individualized discounted offer, one retailer is determined to provide the highest net value NV greater than one or positive for consumer 62. The highest net value retailer based on the regular price less the modified individualized discounted offer moves into or retains first position.

Retailers 190-194 authorize personal assistant engine 74 to continue to increment their respective individualized discounted offer to a lesser value and higher final price FP to consumer 62 in moving toward the optimal individualized discount. Personal assistant engine 74 recalculates and tracks the net value of the DP1-DP3 products to consumer 62 during each bidding round of modifying the individualized discounted offers. As the final price FP increases with the lesser discounted offers, the net value for the DP1-DP3 products will one-by-one become less than one or negative using the first and second normalizing definitions, respectively. In other words, at some point in the bidding rounds, the net value of one of the DP1-DP3 products will become less than one or negative. The net value of another DP1-DP3 product will become less than one or negative in the same bidding round or at a later bidding round. The last standing DP1-DP3 product with a net value greater than one or positive, i.e., with the other products having been eliminated or otherwise have dropped out of the competition, is the winning retailer. The last standing DP1-DP3 product with the least individualized discounted offer still yields a net value greater than one or positive value is the price tipping point for consumer 62 to make a positive purchasing decision for one product, i.e., the least individualized discounted offer that would entice the consumer to purchase one product. The winning retailer with the highest net value using the least individualized discounted offer is selected as the best value for consumer 62 and is placed in first position on optimized shopping list 144.

In each of the above examples of determining net value for consumer 62, multiple brands and/or retailers for a single product can be placed on optimized shopping list 144. Personal assistant engine 74 can place, say the top two or top three net value brands and/or retailers on optimized shopping list 144, and allow the consumer to make the final selection and purchasing decision.

The consumer patronizes retailers 190-194, either in person or online, with optimized shopping list 144 and individualized discounted offers 145 from personal assistant engine 74 in hand and makes purchasing decisions based on the recommendations on the optimized shopping list. Based on optimized shopping list 144, consumer 62 patronizes the DP3 product from retailer 194, BC2 product from retailer 192, CS3 product from retailer 194, BG1 product from retailer 190, FP2 product from retailer 192, and FV1 product from retailer 190. The optimized shopping list 144 gives consumer 62 the ability to evaluate one or more recommended products, each with an individualized discount customized for consumer 62 to make a positive purchasing decision. The consumers can rely on personal assistant engine 74 as having produced a comprehensive, reliable, and objective shopping list in view of the consumer's profile and weighted product preferences, as well as retailer product information, that will yield the optimal purchasing decision to the benefit of the consumer. The individualized discounted price should be set to trigger the purchasing decision. Personal assistant engine 74 helps consumers quantify and develop confidence in making a good decision to purchase a particular product from a particular retailer at the individualized “one-to-one” discounted offer 145. While the consumer makes the decision to place the product in the basket for purchase, he or she comes to rely upon or at least consider the recommendations from consumer service provider 72, i.e., optimized shopping list 144 and individualized discounted offers 145 contributes to the tipping point for consumers to make the purchasing decision. The consumer model generated by personal assistant engine 74 thus in part controls many of the purchasing decisions and other aspects of commercial transactions within commerce system 60.

The optimized shopping list 144 with individualized discounts can be transferred from consumer computers 164-166 to cell phone 116. Consumers 62-64 patronize retailers 190-194, each with optimized shopping list 144 from personal assistant engine 74 in hand and make purchasing decisions based on the recommendations on the optimized shopping list. The individualized discounted prices are conveyed to retailers 190-194 by electronic communication from cell phone 116 to the retailer's check-out register. The discounted pricing can also be conveyed from consumer computer 164-166 directly to retailers 190-194 and redeemed with a retailer loyalty card assigned to the consumer. Retailers 190-194 will have a record of the discounted offers and the loyalty card will match the consumer to the discounted offers on file. In any case, consumers 62-64 each receive an individualized discounted offer as set by personal assistant engine 74.

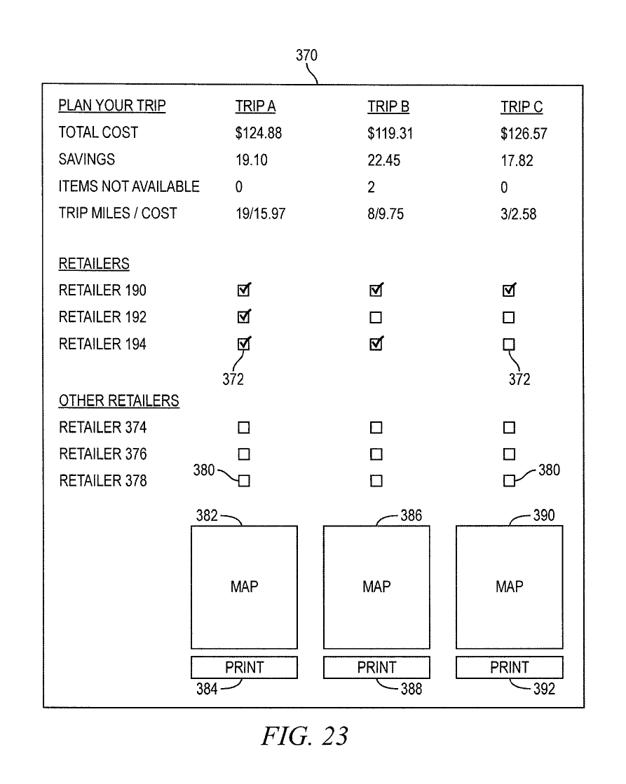

Personal assistant engine 74 can plan the shopping trip for consumer 62 to patronize one or more retailers identified on optimized shopping list 144. The shopping trip may involve multiple stops during one excursion away from home, or the shopping trip can occur over multiple excursions from home over multiple days. In another embodiment, multiple variations of the shopping trip are presented for consumer 62 to select the option best suited to the activities of the day. After reviewing optimized shopping list 144 on webpage 330 in FIG. 19, consumer 62 clicks on plan trip button 341. FIG. 23 illustrates webpage 370 with details of multiple proposed shopping trips for consumer 62 to patronize the retailers 190-194 with optimized shopping list 144.

Under the trip plan A option, consumer 62 can expect a total cost of $124.88 with $19.10 in savings. The total costs include the prices of the items on optimized shopping list 144, actual fuel cost, estimated automobile operating cost per mile, childcare while shopping, value of time, and convenience value. Consumer 62 should expect no items to be unavailable. The length of trip plan A is 19 miles with associated cost of $15.97. Consumer 62 will patronize retailers 190, 192, and 194 as indicated by the checked boxes 372. Other retailers 374, 376, and 378 are noted as being on the trip path or in the vicinity of retailers 190-194. Retailers 374-378 can include specialty outlets such as a gas station, pharmacy, auto wash, or cleaners. Consumer 62 can click on one or more boxes 380 to add retailers 374-378 to trip plan A. In another embodiment, consumer 62 can identify other necessary stops separate and apart from retailers 190-194. For example, consumer 62 may need to stop and pick up children from school. Personal assistant engine 74 takes the consumer-defined necessary stops into account for the trip plan. A map of trip plan A is presented in block 382 with print button 384 to print directions, route, agenda, and stops. Personal assistant engine 74 plans the route for trip plan A with knowledge of construction delays, road closures, and community events.

Under the trip plan B option, consumer 62 can expect a total cost of $119.31 with $22.45 in savings. Consumer 62 should expect two items to be unavailable. The length of trip plan B is 8 miles with associated cost of $9.75. Consumer 62 will patronize retailers 190 and 194 as indicated by the checked boxes 372. The optimized shopping list 144 is modified for all items to be purchased at retailers 190 and 194. Other retailers 374, 376, and 378 are noted as being on the trip path or in the vicinity of retailers 190 and 192. Consumer 62 can click on one or more boxes 380 to add retailers 374-378 to trip plan B. In another embodiment, consumer 62 can identify other necessary stops separate and apart from retailers 190 and 194. For example, consumer 62 may need to stop and pick up children from school. Personal assistant engine 74 takes the consumer-defined necessary stops into account for the trip plan. A map of trip plan B is presented in block 386 with print button 388 to print directions, route, agenda, and stops. Personal assistant engine 74 plans the route for trip plan B with knowledge of construction delays, road closures, and community events.

Under the trip plan C option, consumer 62 can expect a total cost of $126.57 with $17.82 in savings. Consumer 62 should expect no items to be unavailable. The length of trip plan B is 3 miles with associated cost of $2.58. Consumer 62 will patronize retailer 190 as indicated by the checked box 372. The optimized shopping list 144 is modified for all items to be purchased at retailer 190. Other retailers 374, 376, and 378 are noted as being on the trip path or in the vicinity of retailer 190. Consumer 62 can click on one or more boxes 380 to add retailers 374-378 to trip plan C. In another embodiment, consumer 62 can identify other necessary stops separate and apart from retailer 190. For example, consumer 62 may need to stop and pick up children from school. Personal assistant engine 74 takes the consumer-defined necessary stops into account for the trip plan. A map of trip plan C is presented in block 390 with print button 392 to print directions, route, agenda, and stops. Personal assistant engine 74 plans the route for trip plan C with knowledge of construction delays, road closures, and community events. Consumer 62 can choose any one of trip plan A-C based on total cost, convenience, and product availability.

Consumer 62 chooses the preferred trip plan and prints the directions, route, agenda, and stops. Consumer 62 can also download the trip plan into cell phone 116 or GPS navigation tool. By following the trip plan, consumer 62 can efficiently conduct the shopping excursion while saving time and money.

Personal assistant engine 74 can generate an optimized shopping list based on the preference of consumer 62 to patronize a limited number of retailers 190-194. Shopping is a time consuming and expense driven activity with associated costs to consumer 62. The associated costs, such as gas, childcare while shopping, time, aggravation with crowds, inconvenience of traveling to multiple retailers, and potential that the product might be out-of-stock at the retailer having the lower price, can be a significant component in the purchasing decision. Consumer 62 may be unwilling to drive additional distance to another retailer and deal with the long check-out lines just to save a relatively small amount on one product, assuming the other retailer even has the product in stock.

In other cases, retailer 190 may want to incentivize consumer 62 to conduct most if not all their shopping at the retailer's store, i.e., retailers want to encourage one-stop shopping to their store. Retailer 190 may utilize a loss leader marketing approach by selling certain products at below-cost pricing with the expectation of making up the lost profit on other products purchased by consumer 62 at regular or higher margin.

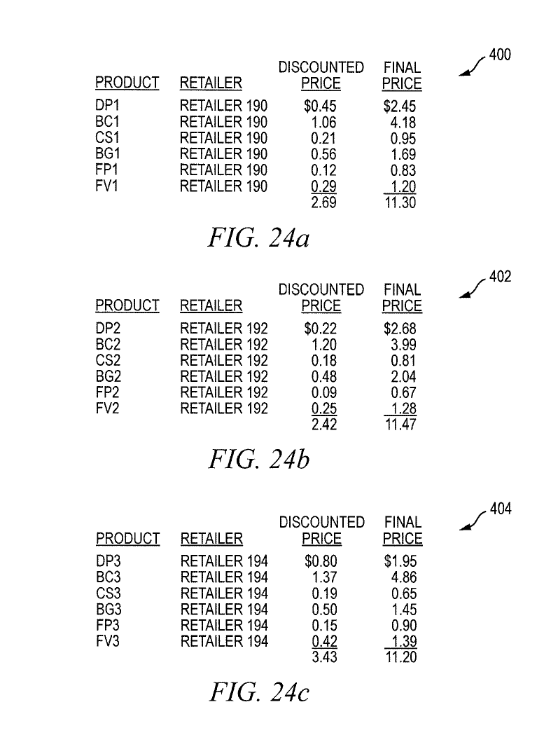

Personal assistant engine 74 generates one or more optimized shopping lists with all of the products on the list directed exclusively to one retailer. The optimized shopping list represents an aggregation of the consumer's purchasing needs directed toward one retailer or a limited number of retailers. If the optimized shopping list is generated at the request of consumer 62, then personal assistant engine 74 generates a first optimized shopping list 400 with all products on the list directed to retailer 190 in FIG. 24a, second optimized shopping list 402 with all products on the list directed to retailer 192 in FIG. 24b, and third optimized shopping list 404 with all products on the list directed to retailer 194 in FIG. 24c. Personal assistant engine 74 uses the individualized discounted offers 145 from retailer 190 for optimized shopping list 400, individualized discounted offers 145 from retailer 192 for optimized shopping list 402, and individualized discounted offers 145 from retailer 194 for optimized shopping list 404. While consumer service provider 72 has knowledge of total shopping list, each retailer 190-194 is competing for designation as the sole source for all of the products identified by consumer 62 for purchase. The net value NV can be based on the aggregation of products on the optimized shopping list. That is, an average net value NV for the aggregated products influences the decision for consumer 62 to purchase all of the product from one retailer 190-194.

Consumer 62 evaluates the three optimized shopping lists 400-404 directed toward retailers 190-194, respectively, and selects one optimized shopping list and associated retailer to patronize based on retailer preference, convenience of location, time of day, time commitments, other errands close to the retailer, aggregate savings, and total cost for all of the products on the shopping list. Retailer 190 is located two miles away from consumer 62 with a total cost of $280.00 for all of the products on the shopping list. Retailer 192 is located ten miles away from consumer 62 with a total cost of $275.00 for all of the products on the shopping list. Retailer 194 is located five miles away from consumer 62 with a total cost of $300.00 for all of the products on the shopping list. In one example, consumer 62 selects retailer 190 with emphasis on the shortest travel distance (two miles), even though the total cost for all of the products on the shopping list from retailer 190 is $5.00 more than retailer 192. The extra eight miles to travel to retailer 192 is not worth the $5.00 in savings. In another example, consumer 62 selects retailer 192 with emphasis on the total cost for all of the products on the shopping list and knowledge that the consumer needs to travel in the general direction of the retailer for other commitments. As long as consumer 62 is going that direction anyway, he or she might as well take advantage of the additional $5.00 in savings from retailer 192. In another example, consumer 62 selects retailer 194 with emphasis on retailer preference. Retailer 194 is farther away than retailer 190 and more expensive than either retailer 190 or retailer 192, but consumer 62 prefers to shop at retailer 194 and the lower cost of retailers 190 and 192 is insufficient to overcome the retailer preference. On the other hand, consumer 62 may have selected retailer 190 or 192 if the relative savings are greater or the total cost for all of the products on the shopping list is substantially less. In each case, consumer 62 makes personal judgments based on retailer preference, convenience of location, time of day, time commitments, other errands close to the retailer, aggregate savings, and total cost for all of the products on the shopping list.

Consumer 62 can request an optimized shopping list limited to a predetermined number of retailers, say two retailers. Personal assistant engine 74 generates the optimized shopping list for the predetermined number of retailers that provide the best overall value for consumer 62. In one embodiment, the products on the optimized shopping list are divided between the two retailers based on the lowest cost to consumer 62.

Consumer 62 patronizes the selected retailer(s) and purchases the products on the optimized shopping list. In some cases, the selected retailer may not carry a product or be out-of-stock on the optimized shopping list. The retailer can compensate with additional discounts or substitute products. If consumer 62 authorizes more than one retailer, then the optimized shopping list directs the consumer to the alternate retailer for the needed product. The receipt for the optimized shopping list provided to consumer 62 after check-out confirms the aggregate savings. Consumer 62 benefits by the convenience of one-stop shopping and discounts from the aggregated shopping list. The selected retailer benefits by increasing sales while maintaining an acceptable profit.

The optimized shopping lists 400-404 are based on the assumption that consumer 62 will purchase all of the products from the single retailer or from the limited number of retailers. In some cases, consumer 62 may not in fact purchase all of the products on the optimized shopping lists 400-404 from the single retailer or from the limited number of retailers. Consumer 62 may change his or her mind at the time of purchase for a variety of reasons, e.g., product no longer needed or product out-of stock. Retailers 190-194 can factor some percentage of products that are not purchased into determining the discounts that still result in an overall profit for the shopping list. For example, retailers 190-194 assume that consumer 62 will actually purchase 95% of the total value of the optimized shopping list. The discounts are determined based on the profit margin for consumer 62 purchasing 95% of the aggregated products value on the optimized shopping list. Retailers 190-194 can track individual consumer purchases and determine which consumers routinely purchase the value of all products and which consumers routinely purchase significantly less than the value of all products on the optimized shopping list. The consumers who regularly purchase the value of all products, or close to the value of all products, on the optimized shopping list are given greater discounts. The consumers who regularly purchase significantly less than the value of all products on the optimized shopping list are given lesser discounts. In another embodiment, the discounted offers can be allocated at the point of sale to correspond to the value of the products purchased. That is, consumer 62 gets the full discounted offers if all or substantially all products on the optimized shopping list are in fact purchased. The discounted offers will be less if consumer 62 fails to purchase all or substantially all products on the optimized shopping list. The proposed discounted offers from the single retailer are honored if and only if consumer 62 in fact purchases all or substantially all products on the optimized shopping list. The discounted offers can also be cleared and settled after the point of sale with knowledge of the actual purchases. In any case, the retailer gauges the discounts for the aggregate products on the optimized shopping list to yield an overall profit.

The consumers can rely on personal assistant engine 74 as having produced a comprehensive, reliable, and objective shopping list in view of the consumer's profile and preference level for each weighted product attribute, as well as retailer product information and the individualized discounted offer, that will yield the optimal purchasing decision for the benefit of the consumer. Personal assistant engine 74 helps consumers 62-64 quantify and evaluate, from a myriad of potential products on the market from competing retailers, a smaller, optimized list objectively and analytically selected to meet their needs while providing the best net value. Consumers 62-64 will develop confidence in making a good decision to purchase a particular product from a particular retailer. While the consumer makes the decision to place the product in the basket for purchase, he or she comes to rely upon or at least consider the recommendations from personal assistant engine 74, i.e., optimized shopping list 144 with the embedded individualized discount contributes to the tipping point for consumers to make the purchasing decision. The consumer model generated by personal assistant engine 74 thus in part controls many of the purchasing decisions and other aspects of commercial transactions within commerce system 60.

The purchasing decisions actually made by consumers 62-64 while patronizing retailers 190-194 can be reported back to personal assistant engine 74 and retailers 190-194. Upon completing the check-out process, the consumer is provided with an electronic receipt of the purchases made. The electronic receipt is stored in cell phone 116, downloaded to personal assistant engine 74, and stored in central database 76 for comparison to optimized shopping list 144. The product information in central database 76 can be updated from the electronic receipt. That is, the actual prices for the products on optimized shopping list 144 as charged by the retailer can be confirmed and updated as indicated. The actual purchasing decisions made when patronizing retailers 190-194 may or may not coincide with the preference levels or weighted attributes assigned by the consumer when constructing the original shopping list. For example, in choosing the canned soup, consumer 62 may have decided at the time of making the purchasing decision that one product attribute, e.g., product ingredients, was more important than another product attribute, e.g., brand. Consumer 62 made the decision to deviate from optimized shopping list 144, based on product ingredients, to choose a different product from the one recommended on the optimized shopping list. Personal assistant engine 74 can prompt consumer 62 for an explanation of the deviation from optimized shopping list 144, i.e., what product attribute became the overriding factor at the moment of making the purchasing decision. Personal assistant engine 74 learns from the actual purchasing decisions made by consumer 62 and can update the preference levels of the consumer weighted product attributes. The preference level for product ingredients can be increased and/or the preference level for brand can be decreased. The revised preference levels for the consumer weighted product attributes will improve the accuracy of subsequent optimized shopping lists. The pricing and other product information uploaded from cell phone 116 after consumer check-out to personal assistant engine 74 can also be used to modify the product information, e.g., pricing, in central database 76.

Consumers 62-64 can also utilize personal assistant engine 74 without a product of interest necessarily being on optimized shopping list 144. While patronizing retailer's store with or without optimized shopping list 144, the consumer can take a photo of the barcode of any product of interest using cell phone 116. The photo is transmitted to personal assistant engine 74. Personal assistant engine 74 reviews the consumer weighted attributes for that product and determines the individualized discounted offer available from the retailer for that consumer. If there is no consumer weighted attributes on file for the product of interest, then personal assistant engine 74 can offer a default individualized discount determined by the personal assistant engine and/or the retailer. The individualized discount is transmitted back to the consumer and displayed on cell phone 116. The consumer can make the purchasing decision at that moment with knowledge of the available individualized discounted offer. With the benefits of personal assistant engine 74, consumers 62-64 need no longer pay the stated regular shelf price for virtually any product. Consumers 62-64 can receive an individualized discounted offer for any product at any time.

As another feature of consumer service provider 72, retailers 190-194 can allocate marketing funds to the consumer service provider for distribution as individualized discounts to consumers 62-64. The marketing funds can also originate with manufacturers 32, distributors 36, or other member of commerce system 30, see FIG. 2. Personal assistant engine 74 distributes the marketing funds in the form of individualized discounted offers when compiling optimized shopping list 144. By utilizing personal assistant engine 74, retailers 190-194 are not just randomly distributing a discounted offer, e.g., as with mailbox flyers and coupons, with hope that a consumer might purchase a product from the retailer based on the general discount. By teaming with consumer service provider 72, retailers 190-194 are reaching a targeted market segment, e.g., a specific consumer, that has already acknowledged a need or interest for the product by creating the shopping list via webpage 220 and pop-up windows 240 and 280. The individualized discount from retailers 190-194 is offered to the consumer who is likely to buy or at least has expressed interest in the retailer's product. Retailers 190-194 will have reached the consumer at or near the tipping point in the purchasing decision process. Since the marketing funds are used to support the individualized discounts and the discounts are made available to the consumer at the point of making the purchasing decision via optimizing shopping list 144, and the actual purchasing decision can be measured and correlated by the electronic receipt with the optimized shopping list, the allocation of marketing funds can be tracked by performance based criteria and reported back to retailers 190-194. Retailers 190-194 will know with a level of certainty that the marketing dollar is indeed generating additional revenue and profit.

Consumer service provider 72 may use a business model which involves no cost to the consumers for use of personal assistant engine 74 but rather relies upon a shared percentage of the incremental revenue or profit (used herein interchangeably) earned by choosing the least individualized discounted offer that will result in a positive purchasing decision by the consumer. Retailers 190-194 may share 0-100% of the incremental revenue or profit associated with the various individualized discounts that can be offered to the consumer as compensation to consumer service provider 72. The sharing percentage to consumer service provider 72 will be greater than zero because 0% gives little or no motivation for consumer service provider 72 to recommend the retailer's product. Likewise, the sharing percentage will be less than 100% because that level of sharing would leave no portion for retailers 190-194. In one embodiment, the sharing percentage to consumer service provider 72 is 30-50% of the incremental revenue or profit from the least individualized discounted offer that will result in a positive purchasing decision by the consumer.

In order to maximize purchasing power of a limited budget, consumers must consider alternative products, pricing at various retailers, available coupons and discounts, and forego products that a consumer would otherwise purchase. Access to information is limited and the number of potential retailers and products can make optimizing a budget an overwhelming task. Consumer service provider 72 provides budgeting tools using information such as product attribute information, product-pricing information, product margin information, and special discounts stored in central database 76. Personal assistant engine accepts and considers budget limitations when providing consumers with optimized shopping lists or planning trips or when providing suggestions to enable consumers to meet a budget.

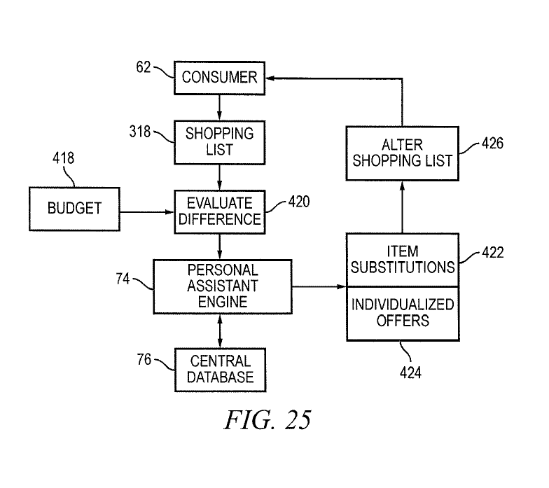

In FIG. 25, product information corresponding to products available for purchase is stored in central database 76. Consumer 62 submits shopping list 318 of products for purchase for comparison with budget 418. The difference 420 between shopping list 318 and budget 418 is evaluated to determine whether the total price of shopping list 318 exceeds budget 418. Personal assistant engine 74 stores shopping list 318 and budget 418 submitted by consumer 62 in central database 76. Personal assistant engine 74 can also store lists of product substitutions, individualized offers, offer history, purchase history, policies, shopping lists, and algorithms for use in evaluating budget 418 and shopping list 318. Shopping list 318 provided by personal assistant engine 74 is specific for each consumer 62. Personal assistant engine evaluates shopping list 318 and budget 418 on a per consumer basis to find any difference between shopping list 318 and budget 418 and provide suggested item substitutions 422 and individualized offers 424 as appropriate. The offers and item substitutions are based in part on the consumer profile, shopping list 318, and budget 418. Item substitutions 422 or individualized offers 424 are selected to alter a shopping list 426 or a price of goods on shopping list 318 based on the difference between budget 418 and shopping list 318. Personal assistant engine 74 also stores budget history and corresponding shopping history in central database 76 to provide consumer 62 access to past budget and shopping trip information.

Given the consumer-generated initial list of products 318 as defined in FIGS. 13-16, personal assistant engine 74 executes a consumer model or comparative shopping service to optimize the shopping list and determine which products should be purchased from which retailers on which day to maximize the value to the consumer as defined by the consumer profile and list of products of interest with weighted attributes. Personal assistant engine takes budget 418 into consideration when providing potential trips to consumer to increase the likelihood that consumer 62 can meet budget 418. Personal assistant engine 74 generates for each specific consumer suggested item substitutions 422 and individualized offers 424, as shown in FIG. 25. Consumer service provider considers each line item of the consumer's shopping list 318 from webpage 220 and pop-up windows 240 and 280 and reviews retailer product information in central database 76 to determine how to best align each item to be purchased with the available products from the retailers and keep the total cost near budget 418. For example, consumer 62 wants to purchase dairy products and has provided shopping list 318 with preference levels for weighted product attributes for milk and other dairy products that are important to his or her purchasing decision and a budget of $4.00. Central database 76 contains dairy product descriptions, dairy product attributes, and pricing for each retailer 190-194. Personal assistant engine 74 reviews the attributes of dairy products offered by each retailer 190-194, as stored in central database 76. The more specific the consumer-defined attributes, the narrower the search field but more likely the consumer will get the preferred product. The less specific the consumer-defined attributes, the wider the search field and more likely the consumer will get the most choices and best pricing. Consumer service provider 72 may provide shopping list 318 with a total price that exceeds budget 418 if the search field is too narrow, no products meet consumer preferences at low enough price, or consumer service provider 72 otherwise determines that consumer 62 may be interested in exceeding budget 418.

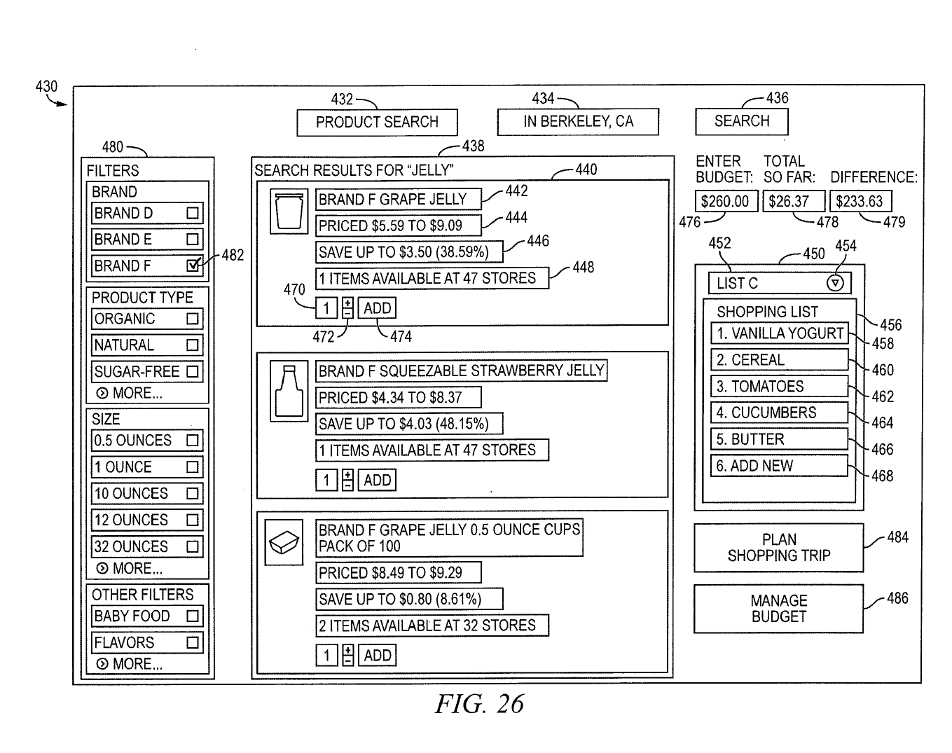

Consumer 62 can prepare shopping list 318 for submission to consumer service provider 72 by loading a saved list, receiving optimized list 144 from personal assistant engine 74, browsing for and adding products to a list, or by searching for and adding products to a list. In FIG. 26, consumer 62 prepares a shopping list using interface 430. Interface 430 enables consumer 62 to search for products by entering text into product search box 432. The location of consumer 62 is displayed in location box 434 and can be modified using a map interface similar to FIG. 11 or providing a location using a city, zip code, address, or other geographical indicator such as a GPS location. Consumer 62 sends a product search to consumer service provider 72 by pressing search button 436 after entering the desired search query into search block 432.

Consumer service provider 72 returns search results for display in results block 438 containing search results matching the search criteria submitted by consumer 62. For example, consumer 62 submits a search for the term “Jelly.” Consumer service provider 72 returns a set of results matching the term jelly. The results can be sorted based on consumer preferences and budget constraints to list the most relevant products for an individual consumer higher in results block 438. Results block 438 displays the first product returned in block 440. The product name of the first entry is Brand F Jelly, displayed in block 442. The prices at nearby retailers range from $5.59 to $9.09 as shown in price block 444. Savings block 446 displays $3.50 as the amount that consumer 62 can save by purchasing the product in block 440. Availability block 448 informs consumer 62 that Brand F Grape Jelly is available at 47 locations nearby.

List C is the active shopping list as shown in shopping list block 450. The name of the selected list is shown in block 452. Other lists can be selected using button 454 and selecting saved lists using a drop down menu, radio buttons, or links. Shopping list 456 displays the contents of the selected shopping list, List C in the present example. Items in shopping list 456 are displayed in blocks 456-466, including vanilla yogurt, cereal, tomatoes, cucumbers, and butter. New items can be added by searching or browsing using the add button in block 468.

Consumer 62 adds Brand F Grape Jelly to shopping list 456 by setting quantity 470 to one using increment buttons 472 and pressing add button 474. Consumer 62 has entered a budget of $260.00 in block 476. The products selected in the shopping list total $26.37 prior to consumer 62 adding Brand F Grape Jelly. When consumer presses add button 474 to add Brand F Grape Jelly to the shopping list, the cost of the selected product is added to the running total in block 478 so that block 478 displays the total cost of products in shopping list 456. The product in block 440 shows a price between $5.59 and $9.09 in block 444 denoting the minimum and maximum price for Brand F Grape Jelly at local retailers. The price of Brand F Grape Jelly can be calculated before or after tax with the minimum and maximum price reflecting the price of the product with different tax rates at different retailers. The total price of the shopping list displayed in block 478 can also be calculated before or after tax, with the amount of tax varying depending on the location of retailers selling the product added to the shopping list. Consumer service provider 72 can calculate the total displayed in block 478 based on the minimum, maximum, median, or average product price. The total price displayed in block 478 can also reflect estimated travel costs including fuel costs, toll expenses, public transit fares, or other travel costs based on the location of consumer 62 and the locations of retailers offering the selected product to more accurately estimate the total cost to consumer 62.

The difference between the budget and the total price of the shopping list is displayed in block 479 and represents the amount of budget remaining for additional products. For example, if consumer 62 sets a budget of $260.00 and has made list 456 comprising $26.37 in products, then block 479 displays $233.63 as the total amount of budget remaining. Consumer 62 uses the running total in block 478 as an estimate of the total cost of shopping list 456. In the present example, the total displayed in block 478 is calculated using the minimum product cost. When consumer 62 presses add button 474, Brand F Grape Jelly is added to shopping list 456 and the total is increased by $5.59, from $26.37 to $31.96. The difference in block 479 decreases from $233.63 to $228.04 to inform the consumer that the remaining unallocated budget is $228.04. The running total remains less than the submitted budget in block 476 indicating that consumer 62 is likely within the $260.00 budget.

Consumer 62 can filter search results using filters 480. Filters 480 hide products in search results block 438 that do not match the filter criteria. For example, consumer 62 selects filter 482 for Brand F and as a result, all products from companies other than Brand F are hidden in search results block 438. Search filters allow consumer 62 to efficiently review search results by hiding products that consumer 62 is not interested in purchasing. Search filters can be based on brand, product type, size, quantity, flavor, color, or any other product attribute.

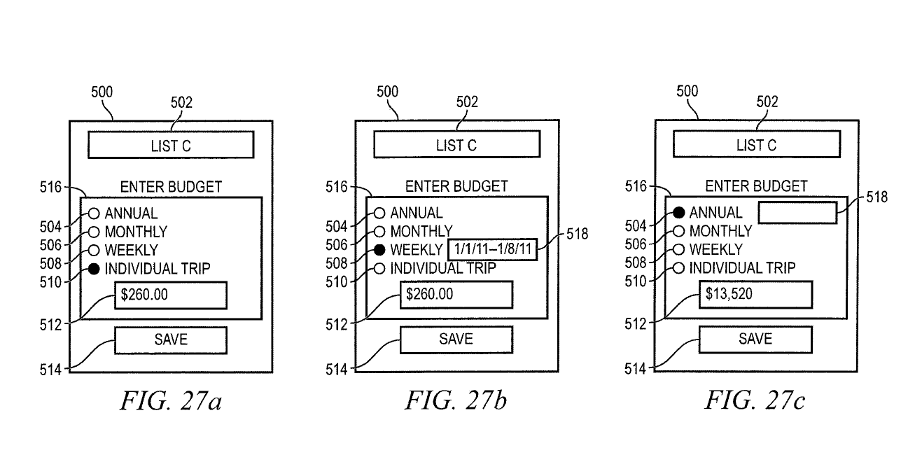

Consumer 62 selects the manage budget feature using button 486. Manage budget button 486 allows consumer 62 to select a budget to apply to shopping list 456 or modify an existing budget currently being applied to shopping list 456, i.e., the budget of $260.00 displayed in block 476. When consumer 62 presses manage budget button 484 a budget interface is provided as shown in FIGS. 27a-27c. Budget interface 500 can be a pop-up window, a web page, an application screen, or other visual input/output interface. FIG. 27a shows consumer 62 selecting an individual trip budget of $260.00 that applies to list C using interface 500. The active shopping list is displayed in block 502 as List C. Consumer 62 can select to apply an annual budget to list C by selecting annual radio button 504. Consumer 62 can select a monthly budget to apply to list C by selecting monthly radio button 506. Consumer 62 can select a weekly budget to apply to list C by selecting weekly radio button 508. An annual, monthly, or weekly budget can apply to multiple shopping lists during the period of the budget. An individual trip budget applies only to one shopping list or trip. In the present example, consumer 62 selects an individual trip budget to apply to list C using individual trip button 510. Consumer 62 enters $260.00 as the desired budget amount into budget field 512. Consumer 62 saves the budget settings using save button 514. The budget interface closes when consumer saves the updated budget and consumer 62 is returned to interface 430 to add products to list 456 or plan a shopping trip.

Consumer may need to stretch a budget over a time period or a number of trips. FIG. 27b shows consumer 62 selecting a weekly budget of $260.00 using button 508. Consumer uses weekly button 508 rather than individual trip button 510 to apply the budget to multiple shopping trips within the next week rather than an individual shopping trip. Budget block 516 also contains date range 518. Consumer 62 can alter date range 518 to select a custom date range for the weekly budget in field 512. The budget number entered in field 512 is applied to shopping trips completed within the next week if date range 518 is left in the default state. If a new date range 518 is entered by consumer 62 then the budget amount in field 512 is applied to shopping trips within the new date range. Consumer 62 submits budget information to personal assistant engine 74 by pressing save button 514. Consumer service provider 72 stores budget information with the consumer profile for consumer 62 in centralized database 76 for application to shopping lists and future access. Consumer service provider can access active budgets for subsequent shopping trips along with consumer profile using login information submitted by consumer 62.

FIG. 27c shows consumer 62 using interface 500 to select an annual budget of $13,520.00 using button 504. Consumer uses annual button 504 rather than individual trip button 510 to apply the budget to multiple shopping trips within the next year rather than an individual shopping trip or trips occurring within a shorter period. Budget block 516 can contain date range 518 as shown in FIG. 27b or can require consumer to select predetermined date ranges and omit date range 518. Consumer 62 can alter date range 518 to select a custom date range for budget in field 512 by entering a date into date range 518. The budget number entered in field 512 is applied to shopping trips completed within the next year if date range 518 is left in the default state. If consumer 62 enters a new date range 518 then the amount in field 512 is applied to shopping trips within the period of the new date range. Consumer 62 submits budget information to personal assistant engine 74 by pressing save button 514. Consumer service provider 72 stores budget information with the consumer profile for consumer 62 in central database 76. Consumer service provider can access active budgets for subsequent shopping trips along with consumer profile using login information submitted by consumer 62.

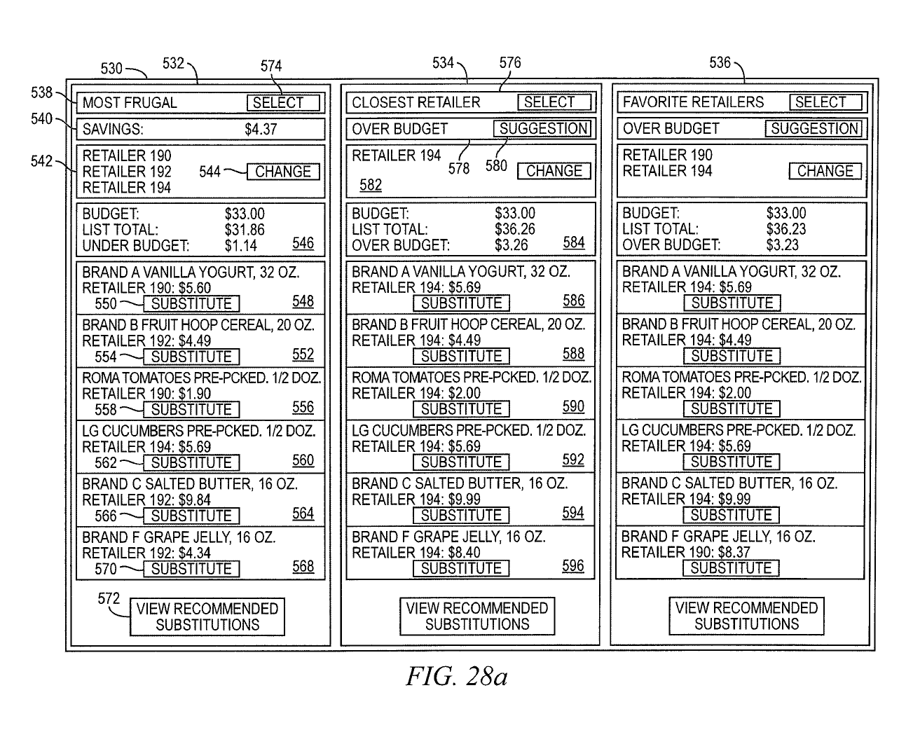

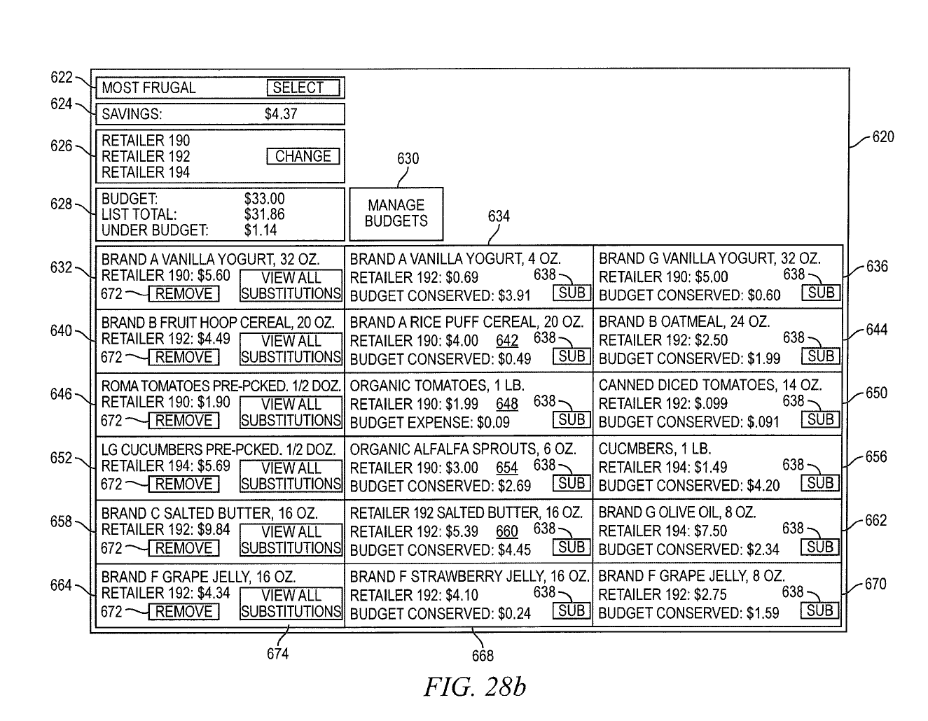

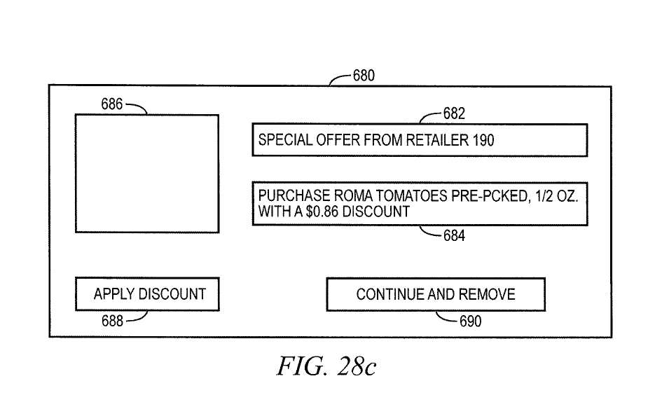

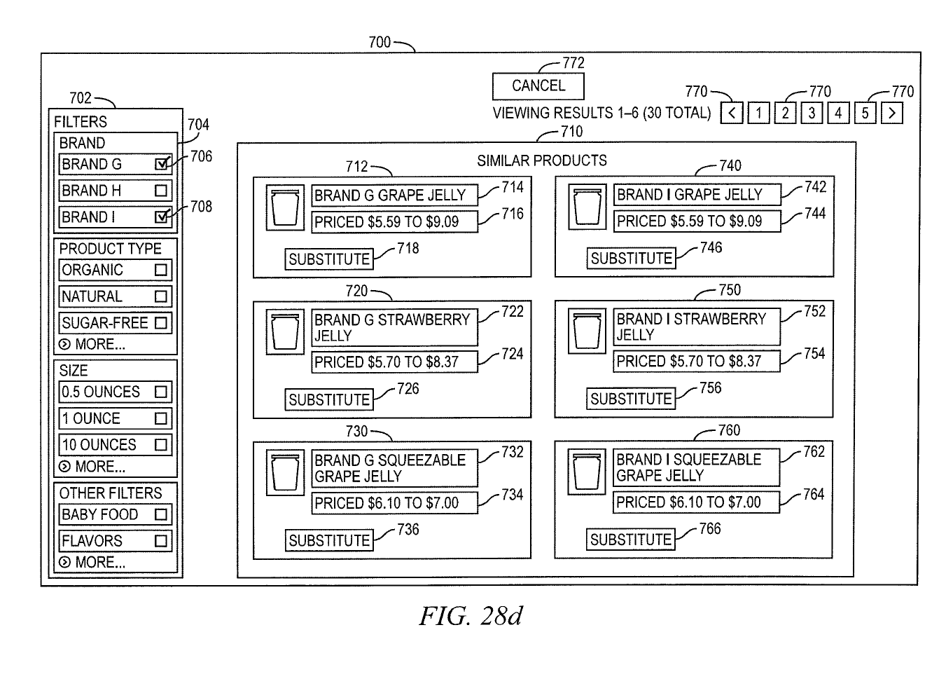

Returning to FIG. 26, after consumer has submitted budget information to consumer service provider 72, consumer 62 presses plan shopping trip button 484 and initiates the trip-planning feature similar to FIG. 23. When button 484 is pressed, consumer 62 submits shopping list 456 to personal assistant engine 74 over communication network 84. Personal assistant engine 74 can process shopping list 456 and consumer budget in block 476 to provide shopping trip recommendations in the form of suggested trips, as shown in interface 530 of FIG. 28a. Interface 530 displays suggested trips 532-536 for shopping list 456 submitted by consumer 62 through interface 430. The trips differ based on the retailers selected, product prices, available individualized discounts, and product availability. Consumer 62 can select a suggested trip 532-536 to start from and use interface 530 to further tailor suggested trips 532-536 to individual needs or desires.

The first trip displayed in interface 530 is trip 532. The title of trip 532 is displayed in block 538 as Most Frugal. Titles can reflect defaults provided by personal assistant engine or titles provided by consumer 62. The amount of savings is displayed in block 540. The savings amount can be calculated by comparing the price of a product in the shopping list to the price of the same product at other local retailers. The potential savings from each product is added together to calculate the total savings displayed in block 540. The retailers included in trip 532 are displayed in block 542. Retailers 190-194 displayed in block 542 are enabled and personal assistant engine will include products from retailers 190-194 in trip 532. Consumer 62 can edit the list of retailers used to generate the trip by pressing change button 544. Consumer can select additional retailers or remove retailers from the list using an interface similar to FIG. 11. When retailers are added or removed the products in trip 532 are adjusted accordingly to reflect the best products for each item on the list based on the products available from the designated retailers. If a retailer is added or removed from the list of retailers in block 542 the total price of the shopping trip 532 is recalculated to reflect lower prices of the added retailers or differing prices of products

Budget details are displayed in block 546. The budgeted amount for trip 532 is $33.00. The total cost of products in trip 532 is $31.86. If consumer 62 selects trip 532 without any modification then consumer 62 will be under budget by $1.14, as shown in block 546. Trip 532 displays each product for purchase along with the retailer where consumer 62 will purchase the product and the product price at the same retailer. The first product in trip 532 is shown in block 548 as Brand A Vanilla Yogurt from retailer 190 with a price of $5.60. Consumer 62 presses substitute button 550 to improve budget conservation by viewing substitutions for Brand A Vanilla Yogurt to find less expensive alternatives. The second product in trip 532 is shown in block 552 as Brand B Fruit Hoop Cereal from retailer 192 with a price of $4.49. Consumer 62 can view substitutions for Brand B Fruit Hoop Cereal by pressing substitute button 554. Trip 532 also contains Roma Tomatoes in block 556. Consumer 62 can view substitutes for Roma Tomatoes by pressing substitute button 558. Trip 532 also contains Large Cucumbers in block 560. Consumer 62 can view substitutes for Large Cucumbers by pressing substitute button 562. Trip 532 also contains Brand C Salted Butter in block 564. Consumer 62 can view substitutes for Brand C Salted Butter by pressing substitute button 566. Trip 532 also contains Brand F Grape Jelly in block 568. Consumer 62 can view substitutes for Brand F Grape Jelly by pressing substitute button 570. Consumer 62 can also view a small set of recommended substitutions for trip 532 using view recommended substitutions button 572. If the consumer wants to select trip 532 as displayed in interface 530, consumer 62 presses select button 574 and no changes are made to trip 532.

Trip 534 is provided as an alternative to trip 532. Trip 534 provides a trip consisting of products available from the nearest retailer. The title of trip 534 is Closest Retailer, as shown in block 576. Trip 534 has only one active retailer, retailer 194, in trip 534 because trip 534 has been suggested as a convenient trip. Consumer service provider 72 projected trip 534 to be the most convenient trip because retailer 194 is the closest retailer to consumer 62 in terms of driving distance, walking distance, or travel time. Block 578 shows that trip 534 would place consumer 62 over budget even though trip 534 would be the most convenient in terms of time and fuel expenses. The over budget alternative is presented to consumer 62 to show the cost of a more convenient trip that may make up for any budget shortcomings with efficiency gains. To increase the likelihood that consumer 62 notices trip 534 is over budget, block 578 displays an over budget warning with additional visual cues to draw the potential budget problem to the attention of consumer 62. For example, in FIG. 28a block 578 is presented with a red color to indicate that trip 534 exceeds the budget provided by consumer 62. Consumer 62 presses suggestion button 580 to view recommended product substitutions that may help consumer 62 get under budget while maintaining the convenience of a single stop shopping trip. Consumer can add additional retailers through block 582 to reduce the total cost listed in block 584, but the resulting trip may require stops at more than one retailer. For example, consumer 62 adds retailer 190 and trip 534 is recalculated to include products from both retailers 190 and 194. The only product less expensive at retailer 190 than retailer 194 is Brand A Vanilla Yogurt from retailer 190, offered at $5.60. The price of Brand A Vanilla Yogurt is $5.69 in block 586 when offered by retailer 194. By adding retailer 190 to block 582 consumer 62 can reduce the total cost by $0.09 by substituting Brand A Vanilla Yogurt from retailer 194 for the same product from retailer 190. However, consumer 62 would forfeit the convenience of one stop shopping for the $0.09 savings. Consumer reverts trip 534 to the originally presented trip 534 by removing retailer 190 and again recalculating trip 534.

The consumers can rely on personal assistant engine 74 as having produced a comprehensive, reliable, and objective information to build a shopping list in view of the consumer's profile and budget. Product information, suggested item substitutions, and individualized discount offers enable consumer to make purchasing decisions to fulfill shopping needs while balancing a budget. Personal assistant engine 74 helps consumers 62-64 quantify and evaluate products from a myriad of competing retailers with varying prices. Consumer service provider 72 controls the commerce system by evaluating shopping lists and corresponding budgets to present information and entice a positive purchasing decision from a consumer through suggestions and offers selected to meet consumer needs. Consumer service provider 72 also influences consumer decisions to purchase or forego items by issuing notifications and warnings regarding budget status. Consumers 62-64 will develop confidence in making a good decision to purchase a particular product from a particular retailer. While the consumer makes the decision to place the product in the basket for purchase, he or she comes to rely upon or at least consider the recommendations and offers from personal assistant engine 74 to reach the tipping point for purchase decisions. The consumer model generated by personal assistant engine 74 in part controls many of the purchasing decisions and other aspects of commercial transactions within commerce system 60.

In another example, consumer 62 is physically shopping at retailer 194 and creating a trip similar to trip 534 by using a portable device to scan products as consumer 62 places the desired products in a shopping cart. Consumer 62 has entered a budget of $33.00 into the portable device to apply to the current shopping trip as an individual trip budget using interface 500. Consumer 62 adds the products in blocks 586-596 to the shopping cart and scans the items with the portable device. Each time a product is scanned, the list total increases. For example, the list total in block 584 starts out at $0.00. Consumer 62 scans Brand A Vanilla Yogurt, 32 oz. and places the product in the shopping cart. The list total increases from $0.00 to $5.69 to reflect the price of Brand A Vanilla Yogurt, 32 oz. Consumer 62 continues adding remaining products in blocks 586-594 to the trip by scanning barcodes on the products and placing them in a shopping cart increasing the trip total to $27.86.

Consumer 62 adds Brand F Grape Jelly to the trip as the last product on her shopping list. The trip total increases from $27.86 to $36.26 putting the trip over the budgeted amount of $33.00. The portable device emits an audible warning by sounding a brief alarm and a visible warning changing the color of the budget entry on the screen from green to red to signify that the total cost exceeds the budget. The colors green and red are preferred for the visual warning but other colors or visual cues can be used as well. Consumer 62 removes the Brand F Grape Jelly from the shopping trip using the portable device and places the product back on the shelves. Personal assistant engine 74 detects the product removal. Knowing that consumer 62 has a budget of $33.00, consumer service provider 72 predicts that consumer 62 is removing the Brand F Grape Jelly from the shopping trip in order to meet the budget. Additionally, consumer service provider 72 calculates that a positive purchasing decision would result from offering a discount on the shopping list equal to the amount that the Brand F Grape Jelly would cause the total cost of the list to exceed the budget. Retailer 194 has authorized consumer service provider to offer a discount of up to 15% on any shopping trip completed entirely at retailer 194. An individual offer is transmitted to consumer 62 and displayed on the portable device to entice a positive purchasing decision for Brand F Grape Jelly. Retailer 194 offers to allow consumer 62 to purchase all products currently in the shopping cart as well as the removed Brand F Grape Jelly for the budget price of $33.00, reflecting a discount of approximately 9% from the retail price. Consumer 62 accepts the individualized offer and adds the Brand F Grape Jelly back to the shopping cart by scanning the barcode. At checkout, the discount offered through consumer service provider 72 is applied and consumer 62 purchases all products listed in trip 534 for the discounted price of $33.00.

Consumer 62 can further reduce the total cost of a proposed shopping trip by replacing products on the shopping trip with less expensive products. Consumer 62 views and selects recommended substitutions for trip 532 by pressing view recommended substitutions button 572 to bring up interface 620, shown in FIG. 28b. Consumer service provider 72 maintains a central database 76 containing records of potential substitute products. Substitute products can be the same product in a smaller quantity, such as substituting a half-gallon of milk into a shopping trip rather than an entire gallon of milk. Although the half-gallon of milk may cost more on a per-ounce basis, the total cost of the half-gallon size is less than the total cost of the one-gallon size. Substituting the smaller, cheaper milk product can reduce the trip total to conserve more of the shopping budget. Substitute products can also include a similar offering from another brand. For example, Store Brand Fruit Hoop Cereal in a 20 oz. box can serve as a replacement for Brand B Fruit Hoop Cereal in a 20 oz. box. In addition to substituting the same type of product from another brand, consumer service provider 72 can also recommend different products. For example, Brand B Wheat Flake Cereal in a 20 oz. box can be a substitution for Brand B Fruit Hoop Cereal in a 20 oz. box.

Interface 620 in FIG. 28b includes information regarding the selected trip including trip name in block 622, savings in block 624, selected retailers in block 626, and active budget information in block 628. Budget information displayed in block 628 includes the total budget amount available for the current trip, the total cost of the proposed shopping trip, and the amount that the trip total is under or over the budget. Consumer 62 can press manage budget button 630 to use the budget interface of FIGS. 27a-27c and change the budget applicable to the current shopping trip.

Personal assistant engine 74 recommends two substitution products for each product appearing in the trip 532. Personal assistant engine recommends products based on budget savings, highest value per dollar, consumer preferences, or similar products. Similar products may have a different manufacturer, flavor, smell, color, packaging, size, or other attribute that is different from an attribute of the product being replaced. For example, consumer 62 selects trip 532 from FIG. 28a by pressing view recommended substitutions button 572 and is presented with recommended substitutions in interface 620. For Brand A Vanilla Yogurt, 32 oz. in block 632, personal assistant engine 74 recommends that consumer 62 consider the smaller sized Brand A Vanilla Yogurt, 4 oz. in block 634 as a substitute. The substitution would result in budget conservation of $3.91. Alternatively, personal assistant engine 74 recommends substituting Brand G Vanilla Yogurt, 32 oz. in block 636 for Brand A Vanilla Yogurt, 32 oz. The substitution would result in budget conservation of $0.60. Consumer 62 substitutes the recommended product in block 634 for the current trip product in block 632 by pressing the corresponding sub button 638 appearing in block 634 with the recommended product. Brand A Vanilla Yogurt, 32 oz. is replaced by Brand A Vanilla Yogurt, 4 oz. in trip 532 and budget information for trip 532 is recalculated to reflect the substitution. The substituted Yogurt product in block 634 costs $0.69, which is $3.91 less than the yogurt product in block 632. The trip total in block 628 is reduced by $3.91 when the substitution is made and block 628 is updated to show $26.95 as the new trip total. Personal assistant engine 74 updates the amount under budget to show $6.05, the new difference between trip total and budget. Consumer 62 can respond to increased budget savings by adding additional products to a shopping list, substituting in preferred products that are more expensive than products on the current list, rolling over the savings into the next budget, or by doing nothing and spending less overall.

For Brand B Fruit Hoop Cereal, 20 oz. in block 632, personal assistant engine 74 recommends Brand B Rice Puff Cereal, 20 oz. block 642 as a substitution. The substitution would result in budget conservation of $0.49. Alternatively, personal assistant engine 74 recommends substituting Brand B Oatmeal, 24 oz. in block 644 for Brand B Fruit Hoop Cereal, 20 oz. The substitution would result in budget conservation of $1.99. Consumer 62 considers both potential substitutions but is partial to fruit hoops type cereal. The savings offered by potential substitution products is outweighed by the preference of consumer 62 for fruit hoops type cereal and consumer 62 declines to substitute either recommended product.

Consumer 62 may want to remove a product from trip 532 in order to reduce the trip total and meet the consumer's budget. For example, consumer 62 is reviewing recommended substitutions for trip 532 after pressing view recommended substitutions button. Consumer 62 updates the budget by pressing manage budget button 630 and reduces the budget for trip 532 to $31.00 from $33.00. The change leaves consumer 62 $0.86 over budget. Substitutions do not interest consumer 62, who likes to purchase particular products and finds little value in substitutes. Consumer 62 realizes that a product must be removed in order to meet the budget. Consumer 62 presses remove button 672 in block 646 corresponding to Roma Tomatoes in order to remove the product from the trip and reduce the trip total by $1.90. consumer service provider 72 detects the product removal through the shopping list update. The removal of tomatoes from the trip indicates that consumer 62 is interested in purchasing the tomatoes but budget constraints are likely causing consumer 62 to exclude Roma Tomatoes. Retailer 190, who was offering the tomatoes at $1.90, does not want to lose the sale of the Roma Tomatoes. Additionally, retailer 190 would like to improve the perception consumer 62 has of the retailer and increase consumer goodwill. Retailer 190 makes an individualized offer through consumer service provider 72 to consumer 62 to purchase the Roma Tomatoes for a $0.86 discount in order to allow consumer 62 to meet the budget and purchase the desired products.

Consumer service provider 72 presents consumer 62 with interface 680 in FIG. 28c. The individualized offer interface 680 identifies the retailer proposing the offer in block 682. The product and discount offer are presented in block 684. Block 686 contains an image of the product. Consumer 62 reviews the individualized offer from retailer 190. The offer enables consumer 62 to meet the desired budget while still purchasing all of the desired products. Consumer presses apply discount button 688 to apply the discount to the product in the shopping trip. Consumer 62 is returned to interface 620 with the discounted prices and totals reflected in product block 646 and budget block 628. The trip total for trip 532 is reduced from $31.86 to $31.00. If consumer 62 wishes to decline the discounted offer and continue to remove the product from trip 532, then consumer 62 presses remove button 690 to confirm product removal.

Returning to FIG. 28b, Consumer 62 may not like the recommended substitutions and instead have a desire to investigate potential substitutions personally to determine if another product might be a better fit. Consumer 62 presses view all substitutions button 674 corresponding to the desired product in order to view substitutions for the desired product. For example, consumer 62 feels that Brand F Grape Jelly in block 664 of trip 532 may not be the ideal jelly product as consumer 62 has preferred other brands in the past. Consumer 62 presses view all substitutions button 674 to reach interface 700 in FIG. 28d. Consumer 62 prefers products from Brand G and Brand I so consumer 62 uses filters 702 to apply a brand filter 704 by selecting Brand G using checkbox 706 and Brand I using checkbox 708. The filters are applied to the similar products block 710 to display similar products to Brand F Grape Jelly that consumer 62 may want to substitute and meet the filter criteria. Similar products include products that have similar attributes or characteristics to the product being replaced, but are slightly different. For example, a similar product may have a different manufacturer, flavor, smell, color, packaging, size, or other attribute that is different from an attribute of the product being replaced.

In the present example, because consumer 62 has chosen to filter the similar products to only include products manufactured by Brands G and I, the similar products shown in block 710 only include products manufactured by Brands G and I. The similar products shown in block 710 include Brand G Grape Jelly, shown in block 712. The product name or description for Brand G Grape Jelly is also indicated in block 714. The product name or description can include any descriptive words, phrases, or images to identify the source or type of product. The price range for Brand G Grape Jelly is indicated in block 716. The price range for each product includes an indication of the lowest price and the highest price for the product among retailers within the preferred geographical area 202 indicated by the consumer, or among the list of preferred retailers 190-194 indicated by consumer 62. In the present example, personal assistant engine 74 indicates that the price for Brand G Grape Jelly among retailers searched by personal assistant engine 74 ranges from $5.59 to $9.09. Consumer 62 substitutes Brand G Grape Jelly for Brand F Grape Jelly by pressing substitute button 718. Consumer service provider removes Brand F Grape Jelly from block 664 and adds Brand G Grape Jelly in block 664 instead.

The similar products shown in block 710 also include Brand G Strawberry Jelly, shown in block 720. The product name or description for Brand G Strawberry Jelly is also indicated in block 722. The product name or description can include any descriptive words, phrases, or images to identify the source or type of product. The price range for Brand G Strawberry Jelly is indicated in block 724. The price range for each product includes an indication of the lowest price and the highest price for the product among retailers within the preferred geographical area 202 indicated by consumer 62, or among the list of preferred retailers 190-194 indicated by consumer 62. In the present example, personal assistant engine 74 indicates that the price for Brand G Strawberry Jelly among retailers searched by personal assistant engine 74 ranges from $5.70 to $8.37. Consumer 62 can substitute Brand G Strawberry Jelly for Brand F Grape Jelly by selecting substitute button 726.

The similar products shown in block 710 also include Brand G Squeezable Grape Jelly, shown in block 730. The product name or description for Brand G Squeezable Grape Jelly is also indicated in block 732. The product name or description can include any descriptive words, phrases, or images to identify the source or type of product. The price range for Brand G Squeezable Grape Jelly is indicated in block 734. The price range for each product includes an indication of the lowest price and the highest price for the product among retailers within the preferred geographical area 202 indicated by consumer 62, or among the list of preferred retailers 190-194 indicated by consumer 62. In the present example, personal assistant engine 74 indicates that the price for Brand G Squeezable Grape Jelly among retailers searched by personal assistant engine 74 ranges from $6.10 to $7.00. Consumer 62 can substitute Brand G Squeezable Grape Jelly for Brand F Grape Jelly by selecting substitute button 736.

The similar products shown in block 710 also include Brand I Grape Jelly, shown in block 740. The product name or description for Brand I Grape Jelly is also indicated in block 742. The product name or description can include any descriptive words, phrases, or images to identify the source or type of product. The price range for Brand I Grape Jelly is indicated in block 744. The price range for each product includes an indication of the lowest price and the highest price for the product among retailers within the preferred geographical area 202 indicated by consumer 62, or among the list of preferred retailers 190-194 indicated by consumer 62. In the present example, personal assistant engine 74 indicates that the price for Brand I Grape Jelly among retailers searched by personal assistant engine 74 ranges from $5.59 to $9.09. Consumer 62 can substitute Brand I Grape Jelly for Brand F Grape Jelly by selecting substitute button 746.

The similar products shown in block 710 also include Brand I Strawberry Jelly, shown in block 750. The product name or description for Brand I Strawberry Jelly is also indicated in block 752. The product name or description can include any descriptive words, phrases, or images to identify the source or type of product. The price range for Brand I Strawberry Jelly is indicated in block 754. The price range for each product includes an indication of the lowest price and the highest price for the product among retailers within the preferred geographical area 202 indicated by consumer 62, or among the list of preferred retailers 190-194 indicated by consumer 62. In the present example, personal assistant engine 74 indicates that the price for Brand I Strawberry Jelly among retailers searched by personal assistant engine 74 ranges from $5.70 to $8.37. Consumer 62 can substitute Brand I Strawberry Jelly for Brand F Grape Jelly by selecting substitute button 756.

The similar products shown in block 710 also include Brand I Squeezable Grape Jelly, shown in block 760. The product name or description for Brand I Squeezable Grape Jelly is also indicated in block 762. The product name or description can include any descriptive words, phrases, or images to identify the source or type of product. The price range for Brand I Squeezable Grape Jelly is indicated in block 764. The price range for each product includes an indication of the lowest price and the highest price for the product among retailers within the preferred geographical area 202 indicated by consumer 62, or among the list of preferred retailers 190-194 indicated by consumer 62. In the present example, personal assistant engine 74 indicates that the price for Brand I Squeezable Grape Jelly among retailers searched by personal assistant engine 74 ranges from $6.10 to $7.00. Consumer 62 can substitute Brand I Squeezable Grape Jelly for Brand F Grape Jelly by selecting substitute button 766.

Consumer 62 can browse additional similar products by navigating through additional pages of similar products using page navigation buttons 770. Consumer 62 can also cancel substituting a product by selecting cancel button 772. Interface 680 may also include the ability for consumer 62 to search for similar products by entering keyword search terms into a text box.

Personal assistant engine 74 helps consumers 62-64 quantify and evaluate products from a myriad of competing retailers with varying prices. Consumer service provider 72 controls the commerce system by evaluating shopping lists and corresponding budgets to present information and entice a positive purchasing decision from consumer 62 through suggestions and offers selected to meet consumer needs. Consumers 62-64 will develop confidence in making a good decision to purchase a particular product from a particular retailer. While the consumer makes the decision to place the product in the basket for purchase, he or she comes to rely upon or at least consider the recommendations and offers from personal assistant engine 74 to reach the tipping point for purchase decisions. Control over consumer purchasing decisions causes the flow of goods between members of the commerce system.

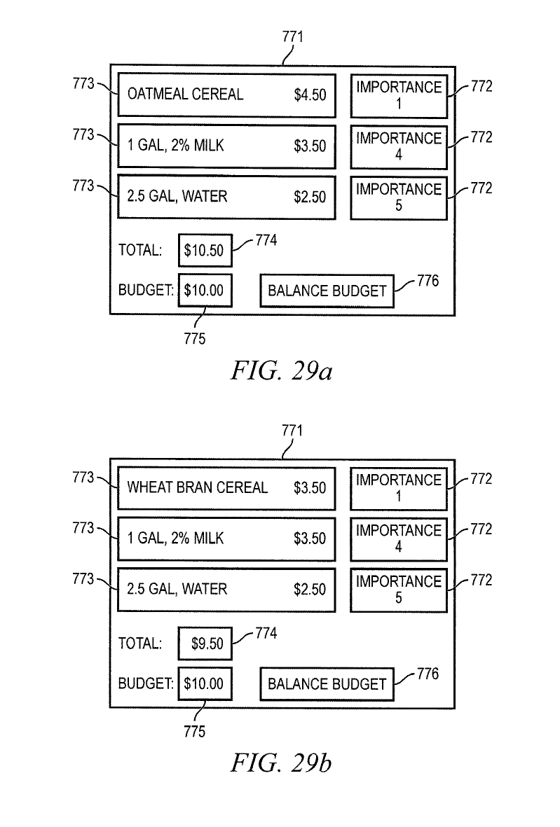

Consumer 62 can use interface 771 in FIG. 29a, provided by consumer service provider 72, to prioritize products for consumer 62 to assist consumer 62 in determining which products are more readily substituted or omitted from a shopping trip from the consumer's perspective. The consumer 62 assigns a numeric value to each product that indicates the consumer's willingness to omit or substitute a product using item importance block 772 corresponding to shopping list product in block 773. Preferences can be entered using a sliding scale, an integer value, check boxes, radio buttons, or any other interface capable of indicating the relative importance of a particular product or type of product to the consumer. Alternatively, the consumer weighted preferences and past shopping habits can be used to deduce a consumer's willingness to substitute a product by making heavily preferred products more important than products that are not preferred.

Consumer service provider 72 uses the item importance ratings from block 772 to indicate that substitute products differing substantially from the product having a low item importance may work as substitutes and the product could even be omitted from a list. Consumer service provider 72 also uses the item importance rating to indicate products of high importance where product substitutes for an important product or omitting an important product from the list is undesirable. Consumer service provider 72 incorporates consumer desires and consumer aspirations into a budgeted shopping trip by balancing the consumer's willingness to substitute a product as indicated in block 772 against the difference between the price in block 774 and budget in block 775. When the difference between the budget and shopping trip total price is positive, i.e., consumer 62 is under budget, consumer service provider 72 can recommend an additional luxury product that consumer would like to add to the trip or substitute in place of an existing product. In general, when producing a shopping list or shopping trips with product substitutions or product omissions, consumer service provider 72 attempts to substitute or remove products with a low item importance from the list first while maintaining as many high importance items, or making minor variations such as size, brand, or flavor depending on consumer preferences, as possible.

For example, an index of product importance ranging from 1-5 is applied by consumer 62, with 1 denoting a replaceable product and 5 denoting an irreplaceable product or necessity. Consumer enters a 1 in block 772, which corresponds to oatmeal cereal in block 773, to indicate that the consumer is quite willing to substitute different products or omit the oatmeal from the shopping list. Consumer inputs a 4 in block 772, which corresponds to 2% milk in block 773, indicating that consumer strongly desires 2% milk on any shopping list and a suitable replacement is unlikely. Consumer 62 enters a 5 in block 772, which corresponds to 2.5 gallon water in block 773, indicating that the consumer is unwilling to substitute another product for the 2.5 gallon water. Oatmeal cereal costs $4.50, a gallon of 2% milk costs $3.50, and a 2.5 gallon water costs $2.50 at the selected retailers. Oatmeal is assigned an importance value of 1 by consumer 62 indicating that consumer 62 is willing to omit or substitute varying products for oatmeal to reduce the shopping list price or increase the shopping list price to match the budget more closely. Oatmeal, a gallon of 2% milk, and a 2.5 gallon water are each on the shopping list for consumer 62 with the total displayed in block 774 as $10.50. Consumer enters a budget of $10.00 for the trip in block 775 or through a budget interface as shown in FIG. 27a-c. Consumer is $0.50 over budget and could meet the budget by removing the 2.5 gallon water. However, consumer 62 will not substitute out or omit the 2.5 gallon water based on the item importance. Likewise, consumer 62 could meet the budget by removing 2% milk from the shopping list but consumer 62 is most likely not willing to remove 2% milk based on the importance value of 4 assigned by consumer 62.

Consumer 62 presses balance budget button 776 to request a shopping list that is balanced against the budget in block 775 and takes item importance from block 772 into consideration. Consumer service provider 72 receives the list, budget, and total price and considers substituting products with lower importance values first. Consumer service provider identifies oatmeal cereal as a strong candidate for replacement or omission based on the item importance of 1 being lower relative to the item importance 4 and 5 assigned to milk and water. Consumer service provider then identifies wheat bran cereal as the best substitute for oatmeal cereal based on the consumer profile of consumer 62, the $3.50 price of wheat bran cereal, and the $10.00 budget. Consumer service provider substitutes wheat bran for oatmeal to reduce the total price of the shopping list to $9.50 and returns a balanced shopping list 771 to consumer 62 as shown in FIG. 29b. Consumer 62 can then reassign item importance values in interface 771 or alter the budget in block 775 and produce a new budgeted shopping list by pressing balance budget button 776. If consumer likes the balanced shopping list returned by consumer service provider 72 as is then consumer can proceed with the balanced trip.

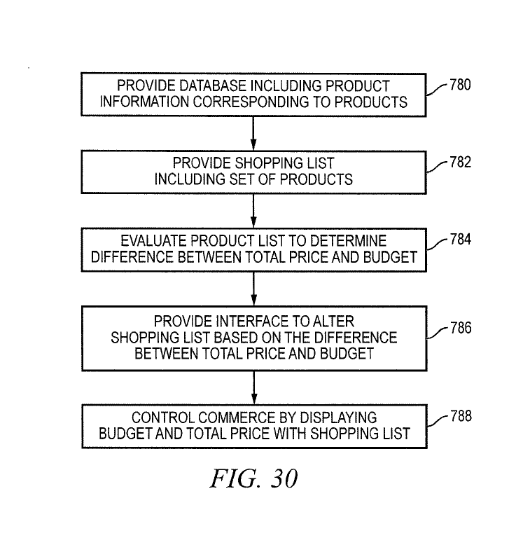

FIG. 30 illustrates a process for controlling a commerce system by enabling the consumer to select the products for purchase from retailers while managing a budget. In step 780, a database is provided including product information corresponding to a plurality of products. In step 782, a shopping list including a set of the products is provided. In step 784, the shopping list is evaluated to determine a difference between a budget and a total price of the shopping list. In step 786, an interface is provided to alter the shopping list or total price of the shopping list based on the difference between the budget and the total price of the shopping list. In step 788, the commerce system is controlled by displaying the budget and total price with the shopping list to influence purchasing decisions.

In summary, the consumer service provider in part controls the movement of goods between members of the commerce system. The personal assistant engine offers consumers economic and financial modeling and planning, as well as comparative shopping services, to aid the consumer in making purchase decisions by optimizing the shopping list according to consumer budgets and consumer-weighted preferences for product attributes. The optimized shopping list requires access to retailer product information. The consumer service provider uses a variety of techniques to gather product information from retailer websites and in-store product checks made by the consumer. The optimized shopping list helps the consumer to make the purchasing decision based on comprehensive, reliable, and objective retailer product information, as well as an individualized discounted offer. By providing substitution recommendations, a consumer service provider helps the consumer to maintain a budget by swapping out expensive products for less expensive substitutions. The individualized discount offers can also be made to entice a positive purchasing decision from consumers and maintain a consumer budget based on the aggregate amount of a shopping list, the aggregate amount of a subset of the shopping list, individual product cost, a budget amount, or a consumer profile. The consumer makes purchases within the commerce system based on the optimized shopping list and product information compiled by the consumer service provider. By following the recommendations from the consumer service provider, the consumer can receive the most value for the money while maintaining control of a budget. The consumer service provider becomes the preferred source of retail information and budgeting tools for the consumer, i.e., an aggregator of retailers capable of providing one-stop shopping.

By providing the consumer an optimized shopping list to make purchasing decisions based on comprehensive, reliable, and objective retailer product information, as well as an individualized discounted offer, the members of the commerce system cooperate in controlling the flow of goods. Retailers benefit by selling more products with a higher profit margin. Consumers receive the best value for the dollar for needed products. Consumer service provider enables an efficient and effective connection between the retailers and consumers.

In particular, enabling the consumer to make purchasing decisions based on the optimized shopping list and maintain a sound budget, e.g., balancing value and budget constraints, operates to control activities within the commerce system. The shopping list and budgeting tools in part control the business interactions of retailers, consumers, and consumer service provider. Retailers offer products for sale. Consumers make decisions to purchase the products. The shopping list and budgeting tools influence how consumer service provider connects the retailers and consumers to control activities within the commerce system.

While one or more embodiments of the present invention have been illustrated in detail, the skilled artisan will appreciate that modifications and adaptations to the embodiments may be made without departing from the scope of the present invention as set forth in the following claims.

What is claimed:

1. A method of controlling a commerce system, comprising:
providing a database including product information corresponding to a plurality of products;
providing a shopping list including a set of the products;
evaluating the shopping list to determine a difference between a budget and a total price of the shopping list;
providing an interface to alter the shopping list or total price of the shopping list based on the difference between the budget and the total price of the shopping list; and
controlling the commerce system by displaying the budget and total price with the shopping list to influence purchasing decisions.

2. The method of claim 1, further including presenting an individualized offer to reduce the total price of the shopping list.

3. The method of claim 1, further including presenting an alternate product to add to the shopping list.

4. The method of claim 3, further including:
adding a product to the shopping list;
updating the total price of the shopping list; and
presenting the total price of the shopping list.

5. The method of claim 1, further including providing a warning to signify that the total price of the shopping list exceeds the budget.

6. The method of claim 1, further including providing an interface to submit the budget.

7. A method of controlling a commerce system, comprising:
providing product information corresponding to a plurality of products;
providing a shopping list including a set of the products;
determining a difference between a budget and a price of the shopping list;
providing an interface to alter the shopping list or price of the shopping list based on the difference between the budget and the price of the shopping list; and
displaying the budget and price with the shopping list to influence purchasing decisions.

8. The method of claim 7, further including presenting an individualized offer to reduce the price of the shopping list.

9. The method of claim 7, further including presenting an alternate product to add to the shopping list.

10. The method of claim 9, further including:
adding the alternate product to the shopping list;
updating the price of the shopping list; and
presenting the price of the shopping list.

11. The method of claim 7, further including providing a warning to signify that the price of the shopping list exceeds the budget.

12. The method of claim 7, further including providing an interface to submit the budget.

13. The method of claim 7, further including identifying one or more retailers where the set of the products on the shopping list can be purchased for the price of the shopping list.

14. A method of controlling a commerce system, comprising:
determining a difference between a budget and a price of a shopping list;
providing an interface to alter the shopping list or price of the shopping list based on the difference between the budget and the price of the shopping list; and
displaying the budget and price with the shopping list.

15. The method of claim 14, further including presenting an individualized offer to reduce the price of the shopping list.

16. The method of claim 14, further including presenting an alternate product to add to the shopping list.

17. The method of claim 16, further including:
adding the alternate product to the shopping list;
updating the price of the shopping list; and
presenting the price of the shopping list.

18. The method of claim 14, further including providing a warning to signify that the price of the shopping list exceeds the budget.

19. The method of claim 14, further including providing an interface to submit the budget.

20. A computer program product usable with a programmable computer processor having a computer readable program code embodied in a non-transitory computer usable medium for controlling a commerce system, comprising:
determining a difference between a budget and a price of a shopping list;
providing an interface to alter the shopping list or price of the shopping list based on the difference between the budget and the price of the shopping list; and
displaying the budget and price with the shopping list.

21. The computer program product of claim 20, further including presenting an individualized offer to reduce the price of the shopping list.

22. The computer program product of claim 20, further including presenting an alternate product to add to the shopping list.

23. The computer program product of claim 22, further including:
adding the alternate product to the shopping list;
updating the price of the shopping list; and
presenting the price of the shopping list.

24. The computer program product of claim 20, further including providing a warning to signify that the price of the shopping list exceeds the budget.

25. The computer program product of claim 20, further including providing an interface to submit the budget.
